(19) United States
(12) Patent Application Publication
(10) Pub. No.: US 2025/0356423 A1
(43) Pub. Date: Nov. 20, 2025

(54) DATA PROCESSING METHOD AND APPARATUS BASED ON BLOCKCHAIN, DEVICE, AND STORAGE MEDIUM

(71) Applicant: TENCENT TECHNOLOGY (SHENZHEN) COMPANY LIMITED, Shenzhen (CN)

(72) Inventors: Gengliang ZHU, Shenzhen (CN); Zongyou WANG, Shenzhen (CN); Yifang SHI, Shenzhen (CN); Qucheng LIU, Shenzhen (CN); Zhiyong LIAO, Shenzhen (CN); Hanqing LIU, Shenzhen (CN); Yangjun HUANG, Shenzhen (CN); Kaixuan NIE, Shenzhen (CN)

(21) Appl. No.: 19/281,743

(22) Filed: Jul. 27, 2025

Related U.S. Application Data
(63) Continuation of application No. PCT/CN2023/132037, filed on Nov. 16, 2023.

(30) Foreign Application Priority Data
May 30, 2023 (CN) 202310626339.1

(51) Int. Cl. G06Q 40/04; G06F 21/64; G06Q 20/38; G06Q 20/40

(52) U.S. Cl. CPC G06Q 40/046; G06F 21/64; G06Q 20/382; G06Q 20/4016

(57) ABSTRACT

A data processing method based on a blockchain includes: receiving, by a first node device associated with a first blockchain, a cross-chain transaction request sent by a service terminal, invoking an on-chain service verification contract in the cross-chain transaction protocol, to verify whether the target cross-chain service is legal according to the service description information, to obtain a service verification result; invoking, in response to the service verification result indicating that the target cross-chain service is legal, an on-chain service execution contract in the cross-chain transaction protocol to execute the target cross-chain service, to obtain cross-chain transaction data; and sending the cross-chain transaction data to N cross-chain relay devices associated with the cross-chain transaction protocol.

### CROSS-REFERENCES TO RELATED APPLICATIONS

This application is a continuation of PCT Application No. PCT/CN2023/132037, filed on Nov. 16, 2023, which claims priority to Chinese Patent Application No. 202310626339.1, filed with the China National Intellectual Property Administration on May 30, 2023 and entitled “DATA PROCESSING METHOD AND APPARATUS BASED ON BLOCKCHAIN, DEVICE, AND STORAGE MEDIUM”, the entire contents of all of which are incorporated herein by reference.

### FIELD OF THE TECHNOLOGY

The present disclosure relates to the field of blockchain technologies, and in particular, to a data processing method and apparatus based on a blockchain, a device, and a storage medium.

### BACKGROUND OF THE DISCLOSURE

A blockchain technology involves distributed infrastructure and computing manner of using a blockchain data structure to verify and store data, using a distributed node consensus algorithm to generate and update data, using cryptography to ensure security of data transmission and access, and using a smart contract including automated script code to program and operate data. To put it simply, a blockchain is a decentralized distributed ledger.

With widespread understanding and recognition of the blockchain technology, many different types of blockchains have emerged. However, blockchains are often independent of each other, and service processing across blockchains is difficult and further requires manual participation. As a result, efficiency of service processing across blockchains is low, data leakage and data loss are prone to occur, and cross-chain service processing security cannot be ensured.

### SUMMARY

Embodiments of the present disclosure provide a data processing method and apparatus based on a blockchain, a device, and a storage medium, to improve cross-chain service processing efficiency and security.

According to one aspect of embodiments of the present disclosure, a data processing method based on a blockchain is provided, including: receiving, by a first node device associated with a first blockchain, a cross-chain transaction request sent by a service terminal, the cross-chain transaction request including service description information of a target cross-chain service associated with the first blockchain and a second blockchain, and both the first node device and a second node device that maintains the second blockchain satisfying a cross-chain transaction protocol; invoking an on-chain service verification contract in the cross-chain transaction protocol, to verify whether the target cross-chain service is legal according to the service description information, to obtain a service verification result; invoking, in response to the service verification result indicating that the target cross-chain service is legal, an on-chain service execution contract in the cross-chain transaction protocol to execute the target cross-chain service, to obtain cross-chain transaction data; and transmitting the cross-chain transaction data to N cross-chain relay devices associated with the cross-chain transaction protocol, a cross-chain relay device i of the N cross-chain relay devices being configured to transmit the cross-chain transaction data to the second node device in response to determining that the cross-chain transaction data is valid based on an off-chain data verification contract in the cross-chain transaction protocol, the second node device being configured to process the received cross-chain transaction data in response to determining that the cross-chain transaction data is valid, N being a positive integer greater than 1, and i being a positive integer less than or equal to N.

According to one aspect of embodiments of the present disclosure, a data processing method based on a blockchain is provided, including: receiving, by a second node device associated with a second blockchain, cross-chain transaction data sent by a cross-chain relay device i of N cross-chain relay devices, the cross-chain transaction data being generated by a first node device by executing a target cross-chain service when determining that the target cross-chain service is legal based on an on-chain service verification contract in a cross-chain transaction protocol, and being forwarded by the first node device to the N cross-chain relay devices, the cross-chain relay device i being configured to transmit the cross-chain transaction data to the second node device in response to determining that the cross-chain transaction data is valid based on an off-chain data verification contract in the cross-chain transaction protocol, the target cross-chain service being associated with a first blockchain maintained by the first node device and the second blockchain, both the first node device and the second node device satisfying the cross-chain transaction protocol, N being an integer greater than 1, and i being an integer less than or equal to N; verifying whether the received cross-chain transaction data is legal based on an on-chain service execution contract in the cross-chain transaction protocol, to obtain a data verification result; and processing the cross-chain transaction data when the data verification result indicates that the cross-chain transaction data is valid.

According to one aspect of embodiments of the present disclosure, a data processing method based on a blockchain is provided, including: receiving, by a cross-chain relay device i of N cross-chain relay devices, cross-chain transaction data sent by a first node device; the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the target cross-chain service being associated with a first blockchain maintained by the first node device and a second blockchain maintained by a second node device, both the first node device and the second node device satisfying the cross-chain transaction protocol, N being an integer greater than 1, and i being an integer less than or equal to N; verifying whether the cross-chain transaction data is valid based on an off-chain data verification contract in the cross-chain transaction protocol; and sending the cross-chain transaction data to the second node device in response to the cross-chain transaction data being valid, the second node device being configured to process the received cross-chain transaction data in response to determining that the cross-chain transaction data is valid.

According to one aspect of the embodiments of the present disclosure, a data processing apparatus based on a blockchain is provided, including: a first receiving module, configured to receive a cross-chain transaction request sent by a service terminal, the cross-chain transaction request including service description information of a target cross-chain service associated with a first blockchain and a second blockchain, and both a first node device and a second node device that maintains the second blockchain satisfying a cross-chain transaction protocol; a first verification module, configured to invoke an on-chain service verification contract in the cross-chain transaction protocol, to verify whether the target cross-chain service is legal according to the service description information, to obtain a service verification result; an execution module, configured to invoke, in response to the service verification result indicating that the target cross-chain service is legal, an on-chain service execution contract in the cross-chain transaction protocol to execute the target cross-chain service, to obtain cross-chain transaction data; and a first transmission module, configured to transmit the cross-chain transaction data to N cross-chain relay devices associated with the cross-chain transaction protocol, a cross-chain relay device i of the N cross-chain relay devices being configured to transmit the cross-chain transaction data to the second node device in response to determining that the cross-chain transaction data is valid based on an off-chain data verification contract in the cross-chain transaction protocol, the second node device being configured to process the received cross-chain transaction data in response to determining that the cross-chain transaction data is valid, N being a positive integer greater than 1, and i being a positive integer less than or equal to N.

According to one aspect of the embodiments of the present disclosure, a data processing apparatus based on a blockchain is provided, including: a second receiving module, configured to receive cross-chain transaction data sent by a cross-chain relay device i of N cross-chain relay devices, the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the cross-chain relay device i being configured to transmit the cross-chain transaction data to the second node device in response to determining that the cross-chain transaction data is valid based on an off-chain data verification contract in the cross-chain transaction protocol, the target cross-chain service being associated with a first blockchain maintained by the first node device and the second blockchain, both the first node device and the second node device satisfying the cross-chain transaction protocol, N being an integer greater than 1, and i being an integer less than or equal to N; a verification module, configured to verify whether the received cross-chain transaction data is legal based on an on-chain service execution contract in the cross-chain transaction protocol, to obtain a data verification result; and a data processing module, configured to process the cross-chain transaction data when the data verification result indicates that the cross-chain transaction data is valid.

According to one aspect of the embodiments of the present disclosure, a data processing apparatus based on a blockchain is provided, including: a third receiving module, configured to receive cross-chain transaction data sent by a first node device; the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the target cross-chain service being associated with a first blockchain maintained by the first node device and a second blockchain maintained by a second node device, both the first node device and the second node device satisfying the cross-chain transaction protocol, N being an integer greater than 1, and i being an integer less than or equal to N; a second verification module, configured to verify whether the cross-chain transaction data is valid based on an off-chain data verification contract in the cross-chain transaction protocol; and a second transmission module, configured to transmit the cross-chain transaction data to the second node device in response to the cross-chain transaction data being valid, the second node device being configured to process the received cross-chain transaction data in response to determining that the cross-chain transaction data is valid.

According to one aspect of the embodiments of the present disclosure, a computer device is provided, including: a processor and a memory; and the processor and the memory being connected, the memory being configured to store a computer program, and the computer program, when executed by the processor, causing the computer device to perform the method provided in the embodiments of the present disclosure.

According to one aspect of the embodiments of the present disclosure, a non-transitory computer-readable storage medium is provided, having a computer program stored therein, the computer program being configured to be loaded and executed by a processor, so that a computer device having the processor performs the method provided in the embodiments of the present disclosure.

The embodiments of the present disclosure provide a cross-chain transaction protocol. The cross-chain transaction protocol includes an on-chain part and an off-chain part. The on-chain part includes the on-chain service verification contract (used to verify whether a cross-chain service is legal), the on-chain service execution contract (used to execute a cross-chain service), and an access condition (that is, a risk management rule) for a node device corresponding to a blockchain to join a cross-chain transaction. The off-chain part includes the off-chain data verification contract used by a cross-chain relay device to verify whether cross-chain transaction data that needs to be forwarded is valid. Cross-chain service processing can be automatically implemented by using these contracts in the cross-chain transaction protocol, thereby improving cross-chain service processing efficiency and security. During actual application, when receiving the cross-chain transaction request sent by the service terminal, the first node device invokes the on-chain service verification contract in the cross-chain transaction protocol, to verify whether the target cross-chain service in the cross-chain transaction request is legal. The first node device invokes, if the target cross-chain service is legal, the on-chain service execution contract in the cross-chain transaction protocol to execute the target cross-chain service, to obtain the cross-chain transaction data. As can be seen, whether the target cross-chain service is legal is verified based on the on-chain service verification contract, and the target cross-chain service is executed only when the target cross-chain service is legal, thereby effectively improving cross-chain service processing security.

Further, the first node device may send the cross-chain transaction data to the N cross-chain relay devices associated with the cross-chain transaction protocol. The cross-chain relay device i of the N cross-chain relay devices is configured to transmit the cross-chain transaction data to the second node device in response to determining that the cross-chain transaction data is valid based on the off-chain data verification contract in the cross-chain transaction protocol. In this way, the N cross-chain relay devices verify whether the cross-chain transaction data is valid, and forward valid cross-chain transaction data. This can implement decentralization and avoid cheating risk of centralization when a third-party cross-chain relay device forwards the cross-chain transaction data (for example, the third-party cross-chain relay device still forwards the cross-chain transaction data to the second blockchain when the cross-chain transaction data is invalid). In addition, the cross-chain relay device verifies whether the cross-chain transaction data is valid, to avoid that a large amount of ledger structure data in the first blockchain is sent to the second blockchain (to verify, on the second blockchain, whether the cross-chain transaction data is valid based on the large amount of ledger structure data), and consequently cross-chain service processing costs are relatively high and cross-chain service processing efficiency is relatively low. Therefore, cross-chain service processing costs can be reduced and cross-chain service processing efficiency can be improved. The second node device processes the received cross-chain transaction data only in response to determining that the cross-chain transaction data is valid, thereby improving cross-chain transaction security.

### BRIEF DESCRIPTION OF THE DRAWINGS

FIG. 1a is a schematic diagram of a blockchain structure according to an embodiment of the present disclosure;

FIG. 1b is a schematic diagram of blockchain generation according to an embodiment of the present disclosure;

FIG. 2 is a schematic diagram of a hierarchical structure of a blockchain network according to an embodiment of the present disclosure;

FIG. 3 is a schematic structural diagram of a blockchain network applied to an electronic bill according to an embodiment of the present disclosure;

FIG. 4 is a schematic diagram of an invoice application scenario of a data processing method based on a blockchain according to an embodiment of the present disclosure;

FIG. 5 is a schematic diagram of a scenario of a data processing method based on a blockchain according to an embodiment of the present disclosure;

FIG. 6 is a schematic flowchart of a data processing method based on a blockchain according to an embodiment of the present disclosure;

FIG. 7 is a schematic flowchart of a data processing method based on a blockchain according to an embodiment of the present disclosure;

FIG. 8 is a schematic flowchart of a data processing method based on a blockchain according to an embodiment of the present disclosure;

FIG. 9 is a schematic diagram of a cross-chain transaction according to an embodiment of the application;

FIG. 10 is a schematic structural diagram of a data processing apparatus based on a blockchain according to an embodiment of the present disclosure;

FIG. 11 is a schematic structural diagram of a data processing apparatus based on a blockchain according to an embodiment of the present disclosure;

FIG. 12 is a schematic structural diagram of a data processing apparatus based on a blockchain according to an embodiment of the present disclosure; and

FIG. 13 is a schematic diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

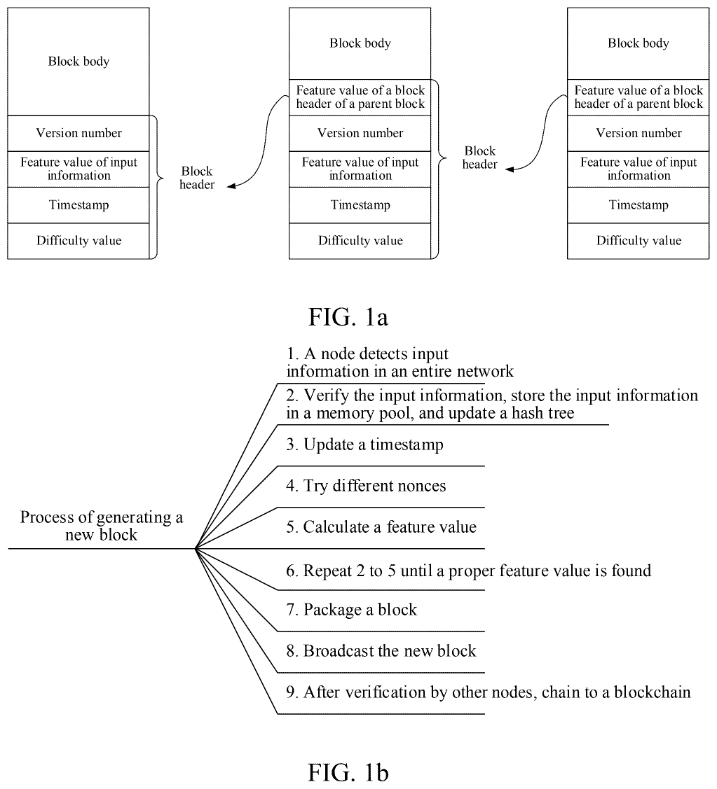

The blockchain is a new application model of computer technologies such as distributed data storage, point-to-point transmission, consensus mechanisms, and encryption algorithms. The blockchain is essentially a decentralized database, and is a string of data blocks generated in a cryptographic manner. Each data block includes information about a batch of network transactions, to verify whether information is valid (anti-counterfeiting) and generate a next block. A blockchain can include a blockchain underlying platform, a platform product service layer, and an application service layer. The blockchain includes a plurality of blocks. FIG. 1a is a schematic diagram of a blockchain structure according to an embodiment of the present disclosure. As shown in FIG. 1a, a blockchain includes a plurality of blocks. A genesis block includes a block header and a block body. The block header stores an input information feature value, a version number, a timestamp, and a difficulty value, and the block body stores input information. A next block of the genesis block uses the genesis block as a parent block, and the next block also includes a block header and a block body. The block header stores an input information feature value of the current block, a block header feature value of the parent block, a version number, a timestamp, and a difficulty value. By analogy, block data stored in each block in the blockchain is associated with block data stored in a parent block, thereby ensuring security of input information in the blocks.

When the blocks in the blockchain are generated, refer to FIG. 1b. FIG. 1b is a schematic diagram of block generation according to an embodiment of the present disclosure. When receiving input information, all nodes perform verification on the input information, store the input information in memory pools after completing the verification, and update hash trees for recording the input information. Subsequently, an update timestamp is updated to a time at which the input information is received, and different nonces are tried to calculate a feature value for a plurality of times. When a nonce that meets the target is obtained through calculation, information may be correspondingly stored, so that a block header and a block body are generated to obtain a current block. Subsequently, the blockchain may broadcast the newly generated current block, that is, send the current block separately to other nodes in a data sharing system where the current block is located. Each node in the data sharing system stores the same blockchain. Another node performs verification on the current block, and after completing the verification, adds the current block to the blockchain stored by the another node.

The blockchain underlying platform may include processing modules such as a user management module, a basic service module, and a smart contract module. The user management module is responsible for identity information management of all blockchain participants, including maintenance of public/private key generation (account management), key management, maintenance of a correspondence between a real user identity and a blockchain address (permission management), and the like. In addition, when authorized, the user management module monitors and audits transactions of some real identities, and provides risk control rule configuration (risk control audit). The basic service module is deployed on all blockchain node devices, and is configured to verify whether a service request is valid, and after completing consensus on a valid request, record the valid request into a storage. For a new service request, the basic service module first performs adaptation analysis and authentication on an interface (interface adaptation), then encrypts service information through a consensus algorithm (consensus management), transmits the encrypted service information to a shared ledger (network communication) in a complete and consistent manner after encryption, and records and stores the encrypted service information. The smart contract module is responsible for registration, issuance, triggering, and execution of a contract. A developer may define contract logic through a specific programming language, publish the contract logic on a blockchain (contract registration), invoke a key or another event to trigger execution based on logic of contract terms, complete the contract logic, and provide functions of contract upgrading and canceling. A smart contract is a computerized protocol, and a term of a contract may be executed. The smart contract is deployed on a shared ledger and executes code implementation when a specific condition is met. According to an actual service requirement, code is configured to complete an automatic transaction.

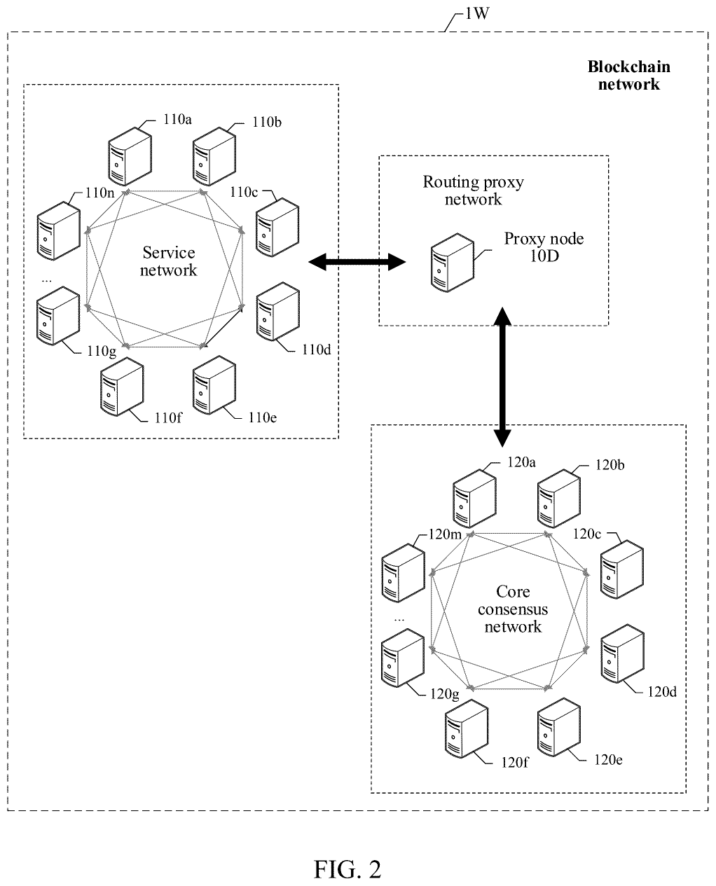

FIG. 2 is a schematic diagram of a hierarchical structure of a blockchain network according to an embodiment of the present disclosure. In this embodiment of the present disclosure, the hierarchical structure of the blockchain network may be a blockchain network 1W shown in FIG. 2. A complete blockchain service system corresponding to the blockchain network 1W may include a service network, a core consensus network, and a routing agent network where an agent node 10D is located in FIG. 2.

One or more agent nodes may be provided in the routing agent network, which is not limited herein. The agent node 10D is used as an example in this embodiment of the present disclosure. The agent node 10D may be configured to perform network isolation on the service network and the core consensus network. The agent node 10D may be a standalone physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, which is not limited herein. The agent node 10D may perform network layering on a peer to peer (P2P) network to form a hierarchical structure of “service network-core consensus network”, thereby improving confidentiality and security of data on a blockchain.

A blockchain node system corresponding to the service network (that is, a witness network) shown in FIG. 2 may include one or more blockchain nodes. A quantity of nodes in the blockchain node system corresponding to the service network is not limited herein. For example, the blockchain node system corresponding to the service network may specifically include a node 110a, a node 110b, a node 110c, a node 110d, a node 110e, a node 110f, a node 110g, . . . , and a node 110n. In the embodiments of the present disclosure, the blockchain node in the service network may be referred to as a service node. The service node does not need to participate in accounting consensus and is mainly configured to execute a transaction service to obtain transaction data associated with the transaction service. The service node herein may be a full node including a complete blockchain database, or a lightweight node storing partial data in a blockchain database, which is not limited herein. In order to reduce a waste of storage space of the service node, the service node in this embodiment of the present disclosure may be, for example, a lightweight node (simplified payment verification (SPV)). The service node does not need to store complete transaction data, and instead, obtains, from the core consensus network shown in FIG. 2 through the agent node 10D, block header data and partially authorized visible block data (for example, a transaction associated with the service node).

A blockchain node system corresponding to the core consensus network shown in FIG. 2 may also include one or more blockchain nodes. A quantity of nodes in the blockchain node system corresponding to the core consensus network is not limited herein. For example, the blockchain node system corresponding to the core consensus network may specifically include a node 120a, a node 120b, a node 120c, a node 120d, a node 120e, a node 120f, a node 120g, . . . , and a node 120m. In the embodiments of the present disclosure, the node in the core consensus network may be referred to as a consensus node (that is, an accounting node), and the consensus node may run a blockchain consensus protocol.

In this embodiment of the present disclosure, the agent node, the service node, and the consensus node may be collectively referred to as blockchain nodes in the blockchain network 1W. The blockchain node may be a server accessing the blockchain network 1W, or a user terminal accessing the blockchain network 1W. A specific form of the blockchain node is not limited herein. The service network and the core consensus network shown in FIG. 2 may be in different network environments. For example, in general, the service node is deployed in a public service network, while the consensus node running the blockchain consensus protocol is deployed in a private core consensus network. The service node and the consensus node may interact through a routing boundary. The service node can access the consensus network after meeting a specific requirement, but because the consensus network is in relatively secure private cloud and there is already a consensus mechanism to ensure security of mutual access, security is very high. However, the service node is in a public network and may be accessed by other uncertain network terminals. Therefore, behaviors of the service node and other possible nodes accessing the consensus network need to be strictly controlled.

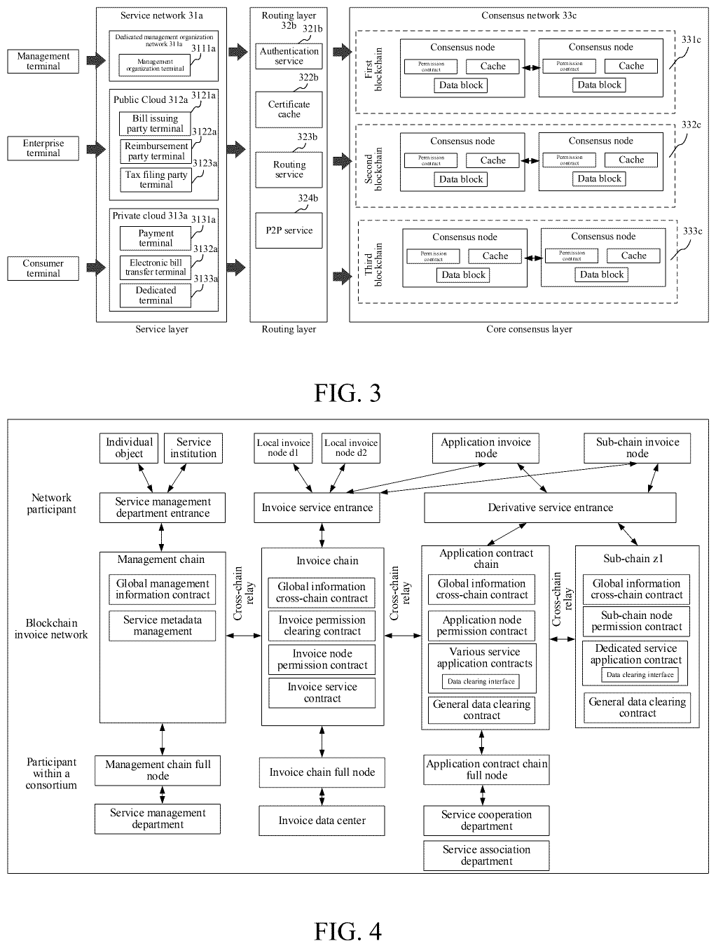

FIG. 3 is a schematic structural diagram of a blockchain network applied to an electronic bill according to an embodiment of the present disclosure. As shown in FIG. 3, when the blockchain network in FIG. 2 is applied to an electronic bill scenario, the blockchain network may record transaction data generated in an entire electronic bill transfer process. As shown in FIG. 3, the blockchain network includes a service network 31a, a consensus network 33c, and a routing layer 32b. The electronic bill transfer process includes processes such as claiming the electronic bill, issuing the electronic bill, reimbursing the electronic bill, and tax filing of the electronic bill. The issuing the electronic bill is also referred to as generating the electronic bill.

Related roles in the entire electronic bill transfer process include a management organization, a bill issuing party, a reimbursement party, and a tax filing party. Therefore, the service network 31a includes a dedicated management organization network 311a providing a related service for the management organization, public cloud 312a providing a related service for the bill issuing party, the reimbursement party, and the tax filing party, and private cloud 313a providing an electronic bill storage service for a consumer. The dedicated management organization network 311a includes a computer device used by the management organization related to the electronic bill, including a management organization terminal 3111a. The management terminal may access the dedicated management organization network 311a. The public cloud 312a includes computer devices used by the bill issuing party, the reimbursement party, and the tax filing party related to the electronic bill, including a bill issuing party terminal 3121a, a reimbursement party terminal 3122a, and a tax filing party terminal 3123a. The bill issuing party may be a billing issuing service provider, and the reimbursement party may be a reimbursement service provider. An enterprise terminal may access the public cloud 312a. The private cloud 313a includes computer devices used by users related to the electronic bill, including a payment terminal 3131a for payment, an electronic bill transfer terminal 3132a configured to temporarily store the electronic bill for users, and a dedicated terminal 3133a for some enterprises. A consumer terminal may access the private cloud 313a. Computer devices in the dedicated management organization network 311a, the public cloud 312a, and the private cloud 313a may all be used as service nodes to send a data chaining request or a data query request for an electronic bill to the consensus network 33c by using the routing layer 32b.

Any routing node in the routing layer 32b includes functional modules for providing an authentication service 321b, a certificate cache 322b, a routing service 323b, and a P2P service 324b. The authentication service 321b is configured to perform identity verification on the service node in the service network 31a, the certificate cache 322b is configured to cache identity certificates of nodes, the routing service 323b is configured to implement network isolation between the service network 31a and the consensus network 33c, and the P2P service 324b is configured to allocate a task between routing nodes. A peer to peer (P2P) network is formed between the routing nodes. A P2P protocol is an application layer protocol that runs above a transmission control protocol (TCP).

The consensus network 33c includes a plurality of consensus branch networks, for example, a first blockchain network 331c, a second blockchain network 332c, and a third blockchain network 333c. Each consensus branch network includes a plurality of consensus nodes (that is, consensus node devices). The plurality of consensus nodes in each consensus branch network maintain a blockchain corresponding to the consensus branch network. For example, the plurality of consensus nodes included in the first blockchain network 331c are configured to maintain a first blockchain corresponding to the first blockchain network 331c. Different blockchains have different roles in the consensus network 33c. For example, some blockchains are configured to record transaction information related to electronic bills within a specific bill number interval, and some blockchains are configured to record transaction information related to re-issued electronic bills. When data related to the electronic bill needs to be recorded, a blockchain to which the data is to be recorded may be determined according to a permission of the service node, and then the data is recorded by a consensus branch network maintaining the blockchain. The consensus node may generally be computer devices used by management organizations of regions.

The consensus node in each consensus branch network includes a permission contract. The permission contract stores transfer logic for an entire lifecycle of an electronic bill, for example, a bill state of the electronic bill, a transfer process, an access permission of data, a claiming condition of the electronic bill, and an issuance condition of the electronic bill. The consensus node further includes a cache and a data block. The functions may provide support for chaining and querying of transaction information. According to the solution, cross-chain data transactions between different blockchains can be achieved, for example, cross-chain data transactions between different blockchains in the service network 31a, or cross-chain data transactions between blockchains in the service network 31a and blockchains in the consensus network 33c, or cross-chain data transactions between different blockchains in the consensus network 33c as shown in FIG. 3.

“Cross-chain” refers to a process of data transaction between blockchain networks. Cross-chain may implement secure interaction between different blockchain networks, to integrate dispersed digital resources into one blockchain network.

In this embodiment of the present disclosure, a first blockchain network to which a first blockchain belongs may be the same as a second blockchain network to which a second blockchain belongs. That is, cross-chain communication between different blockchains in the same blockchain network can be achieved in the present disclosure. For example, the first blockchain and the second blockchain are both blockchains in the consensus network 33c. For example, the first blockchain may be a first blockchain, and the second blockchain may be a second blockchain. Certainly, in this embodiment of the present disclosure, the blockchain network to which the first blockchain belongs may be different from the blockchain network to which the second blockchain belongs. That is, cross-chain communication between different blockchains in different blockchain networks can be achieved in the present disclosure. For example, the first blockchain network to which the first blockchain belongs is the service network 31a, and the second blockchain network to which the second blockchain belongs is the consensus network 33c.

All the node devices in the blockchain network as referred to in this embodiment of the present disclosure each may be a mobile phone, a tablet computer, a notebook computer, a palmtop computer, a mobile Internet device (MID), a vehicle, roadside equipment, an aircraft, and a wearable device, or may be an intelligent device with a data processing function such as a smartwatch, a smart band, or a pedometer. All the node devices may correspond to a same device type or different device types.

The first blockchain in this embodiment of the present disclosure may be any blockchain in the consensus network 33c shown in FIG. 3. For example, the first blockchain may be the first blockchain corresponding to the first blockchain network 331c in the consensus network 33c, or may be the second blockchain corresponding to the second blockchain network 332c in the consensus network 33c, or may be another blockchain in the consensus network 33c. Certainly, the first blockchain in this embodiment of the present disclosure may alternatively be any blockchain in the service network. In this embodiment of the present disclosure, the second blockchain is different from the first blockchain, and a blockchain network to which the first blockchain belongs may be different from or may be the same as the second blockchain network. For example, the first blockchain is a blockchain in the consensus network 33c, and the second blockchain is a blockchain in the service network 31a. Certainly, the first blockchain and the second blockchain both may be different blockchains in the consensus network 33c. The second blockchain may be any blockchain in the consensus network 33c, or may be any blockchain in the service network 31a shown in FIG. 3.

Specifically, the data processing method based on a blockchain provided in the embodiments of the present disclosure can be applied to various scenarios in the blockchain field, to implement cross-chain transactions between different blockchains in the blockchain field. For example, the data processing method based on a blockchain provided in this embodiment of the present disclosure may be applied to an on-chain asset transaction (for example, asset transfer, asset locking, or asset freezing) between different blockchains. For example, an asset may be transferred from the first blockchain to the second blockchain. The data processing method based on a blockchain provided in this embodiment of the present disclosure may be applied to on-chain information sharing between different blockchains. For example, information on the first blockchain may be shared with the second blockchain. Certainly, the data processing method based on a blockchain provided in this embodiment of the present disclosure may be applied to on-chain transaction transfer between different blockchains. For example, a to-be-processed transaction may be transferred from the first blockchain to the second blockchain, to implement performance expansion and reduce load on the first blockchain. Certainly, the method is also applicable to other cross-chain transaction application scenarios. Details are not described herein again.

FIG. 4 is a schematic diagram of an invoice application scenario of a data processing method based on a blockchain according to an embodiment of the present disclosure. As shown in FIG. 4, a data processing method based on a blockchain in the present disclosure may be applied to an invoice application scenario. The invoice application scenario is a multi-chain architecture, such as a management chain, an invoice chain, an application contract chain, and a sub-chain z1. Each blockchain has a corresponding core chain (that is, a blockchain in a consensus network) and a corresponding service node network (that is, a consensus network). A cross-chain communication transaction may be performed between different chains by using a cross-chain transaction protocol. As shown in FIG. 4, an individual object and a service institution may submit a service transaction request to a management chain by using a service management department entrance. A global management information contract is deployed on the management chain, and is configured to manage related information of the individual object or the service institution (for example, information about an invoice that the individual object or the service institution applies for). In addition, the management chain includes service metadata management, configured to manage service description information (for example, a service identifier, service initiating object information, and a service initiating time) of a related service submitted to the management chain. A management chain full node may store all information about a service submitted on the management chain (for example, block information about service submission), and a service management department may obtain information recorded in the management chain full node.

As shown in FIG. 4, a local invoice node d1, a local invoice node d2, an application invoice node, and a sub-chain invoice node may submit a service transaction request to an invoice chain by using an invoice service entrance. A global information cross-chain contract, an invoice permission clearing contract, an invoice node permission contract, and an invoice service contract are deployed on the invoice chain, and are all configured to process the submitted service transaction request. An invoice chain full node may store all information about a service submitted on the invoice chain, and an invoice data center may obtain information recorded in the invoice chain full node. The application invoice node may submit a service transaction request to an application contract chain by using a derivative service entrance. A global information cross-chain contract, an application node permission contract, various service application contracts (including a data clearing interface), and a general data clearing contract are deployed on the application contract chain, and are all configured to process the submitted service transaction request. An application contract chain full node may store all information about a service submitted on an application contract chain, and a service cooperation department and a service association department may obtain information recorded in the application contract chain full node. The sub-chain invoice node may submit a service transaction request to the sub-chain z1 (which may also be another sub-chain) by using a derivative service entrance. A global information cross-chain contract, a sub-chain node permission contract, a dedicated service application contract (including a data clearing interface), and a general data clearing contract are deployed on the sub-chain z1, and are all configured to process the submitted service transaction request.

As shown in FIG. 4, a cross-chain transaction may be performed between the management chain, the invoice chain, the application contract chain, and the sub-chain z1 according to cross-chain relay devices by using the cross-chain technology in the present disclosure. Specifically, for example, a cross-chain transaction is performed between the management chain and the invoice chain. After executing a cross-chain transaction request submitted by an individual object, the management chain may verify whether a target cross-chain service in the cross-chain transaction request is legal, and execute the target cross-chain transaction service when the target cross-chain service is legal, to obtain cross-chain transaction data. Further, a cross-chain relay device may forward the cross-chain transaction data to the invoice chain. In response to determining that the cross-chain transaction data is valid, the invoice chain processes the cross-chain transaction data, to implement a cross-chain transaction between different blockchains.

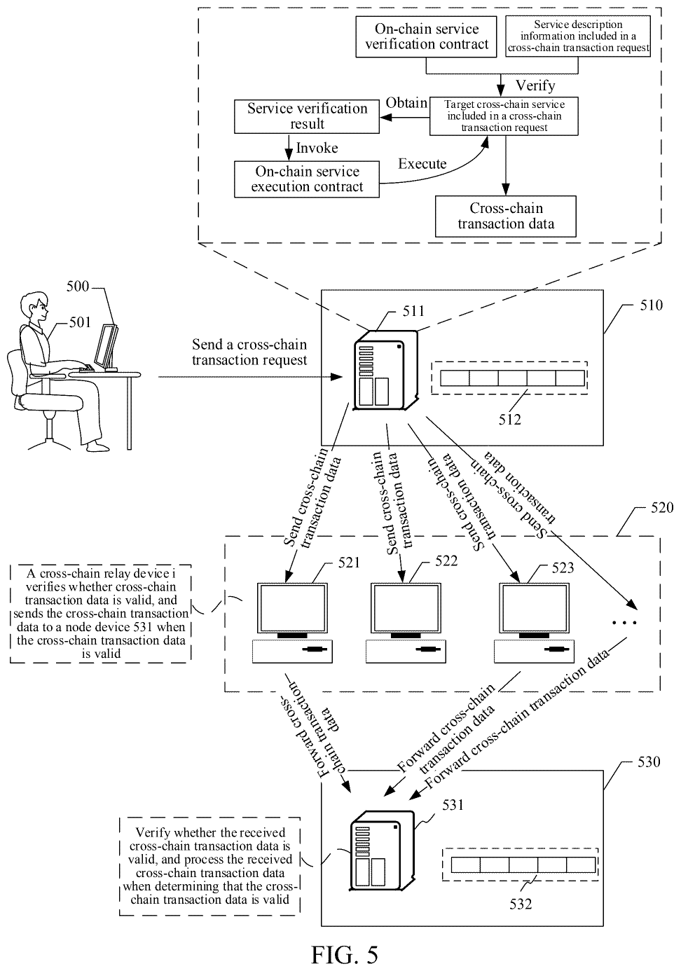

For ease of understanding, further, FIG. 5 is a schematic diagram of a scenario of a data processing method based on a blockchain according to an embodiment of the present disclosure. As shown in FIG. 5, a first blockchain 512 belongs to a first blockchain network 510. The first blockchain 512 includes a plurality of blocks. The first blockchain network 510 to which the first blockchain 512 belongs may be the foregoing core consensus network, and the first blockchain 512 may be a first blockchain corresponding to the first blockchain network 331c in the foregoing core consensus network. As shown in FIG. 5, a second blockchain 532 belongs to a second blockchain network 530. The second blockchain also includes a plurality of blocks. The second blockchain network 530 to which the second blockchain 532 belongs may also be the foregoing core consensus network, and the second blockchain 532 may be a second blockchain corresponding to the second blockchain network 332c in the foregoing core consensus network. The first node device 511 may be any node device of one or more node devices maintaining the first blockchain 512, and the second node device 531 may be any node device of one or more node devices maintaining the second blockchain 532. The service terminal 500 may be a service node maintaining the first blockchain 512, or may be a terminal device (for example, a consumer terminal or an enterprise terminal in FIG. 3) having data communication with the first node device 511.

Node devices in different blockchains all need to satisfy the cross-chain transaction protocol when performing a cross-chain transaction. Satisfying the cross-chain transaction protocol may refer to jointly formulating the cross-chain transaction protocol, joining the cross-chain transaction protocol, and performing the cross-chain transaction based on the cross-chain transaction protocol. The cross-chain transaction protocol is a protocol for interaction and communication between different blockchains, resolves problems of isolation and interoperability between blockchains, and allows cross-chain data and asset transfer and exchange between different blockchains. The cross-chain transaction protocol includes a series of technologies and protocol specifications, including consensus algorithms, encryption technologies, smart contracts, inter-chain communications protocols, and the like. When performing a cross-chain transaction, node devices on different blockchains need to comply with rules of the series of technologies and protocol specifications included in the cross-chain transaction protocol. The first node device 511 and the second node device 531 both meet the cross-chain transaction protocol. In this way, a cross-chain transaction can be implemented between the first node device 511 maintaining the first blockchain 512 and the second node device 531 maintaining the second blockchain 532.

As shown in FIG. 5, the service object 501 may be a possessing object or an operation object of the service terminal 500. The service object 501 may generate a cross-chain transaction request by using the service terminal 500. The cross-chain transaction request includes service description information of a target cross-chain service associated with a first blockchain and a second blockchain. The target cross-chain service may be a cross-chain asset transfer service (for example, transferring a digital asset from the first blockchain to the second blockchain), or may be a cross-chain information sharing service (for example, sharing information in the first blockchain with the second blockchain), or may be a cross-chain transaction transfer service (for example, transferring a transaction from the first blockchain to the second blockchain, to reduce the workload of the first blockchain). The service description information is description information of the target cross-chain service. When the target cross-chain service is transferring a digital asset from the first blockchain to the second blockchain, the service description information of the target cross-chain service may include an asset transfer-out account on the first blockchain, a transfer-out asset amount, a transfer-out asset type, an identifier of the second blockchain, an asset transfer-in account on the second blockchain, a service identifier of the target cross-chain service, and the like. Further, the service terminal 500 may send the cross-chain transaction request initiated by the service object 501 to the first node device 511.

Specifically, the first node device 511 may invoke the on-chain service verification contract in the cross-chain transaction protocol. The on-chain service verification contract invoked by the first node device 511 may be a smart contract deployed on the first blockchain. Node devices maintaining the first blockchain can all invoke the contract when performing a cross-chain transaction. The on-chain service verification contract is used to verify whether the target cross-chain service in the cross-chain transaction request is legal to verify whether the target cross-chain service is a risky transaction (for example, an illegal asset transaction or a transaction that leaks important information (for example, privacy)). Further, the first node device 511 may verify whether the target cross-chain service is legal based on the on-chain service verification contract and the service description information, for example, verify whether the target cross-chain service is a risky transaction, to obtain a service verification result.

In response to the service verification result indicating that the target cross-chain service is illegal (that is, the target cross-chain service is a risky transaction), the first node device 511 does not execute the target cross-chain service. In response to the service verification result indicating that the target cross-chain service is legal (that is, the target cross-chain service is not a risky transaction), the first node device 511 may invoke an on-chain service execution contract in the cross-chain transaction protocol. The on-chain service execution contract invoked by the first node device 511 may be a smart contract deployed on the first blockchain. The on-chain service execution contract may be a cross-chain bridge contract. The received target cross-chain service is processed based on a service processing rule and a cross-chain communication protocol specified in the cross-chain bridge contract. As can be seen, whether the target cross-chain service is legal is verified based on the on-chain service verification contract, and the target cross-chain service is executed only when the target cross-chain service is legal, thereby effectively improving cross-chain transaction security.

The first node device 511 may invoke the on-chain service execution contract to execute the target cross-chain service, to obtain cross-chain transaction data. For example, the target cross-chain service is transferring a digital asset from the first blockchain to the second blockchain. The first node device 511 may invoke the on-chain service execution contract, lock an asset specified by the target cross-chain service on the first blockchain to obtain an asset locking event that the asset specified by the target cross-chain service on the first blockchain has been locked, generate an asset release request used to instruct the second blockchain to release the asset specified by the target cross-chain service to the asset transfer-in account on the second blockchain, and determine the asset locking event and the asset release request as cross-chain transaction data of the target cross-chain service.

Further, the first node device 511 may send the cross-chain transaction data to N cross-chain relay devices 520 associated with the cross-chain transaction protocol. As shown in FIG. 5, the N cross-chain relay devices 520 include a cross-chain relay device 521, a cross-chain relay device 522, a cross-chain relay device 523, . . . , and the like, where N is a positive integer greater than 1. The first node device 511 may send the cross-chain transaction data to each of the N cross-chain relay devices 520. That is, the first node device 511 may send the cross-chain transaction data to the cross-chain relay device 521, send the cross-chain transaction data to the cross-chain relay device 522, send the cross-chain transaction data to the cross-chain relay device 523, and so on. Certainly, the first node device 511 may alternatively lock, by using the on-chain service execution contract, the asset specified by the target cross-chain service, and then send a service success submission event about the target cross-chain service. The N cross-chain relay devices may detect the cross-chain service execution contract on each blockchain. When detecting the service success submission event sent on the first blockchain, the N cross-chain relay devices may obtain the cross-chain transaction data of the target cross-chain service from the first blockchain.

The cross-chain relay device i of the N cross-chain relay devices 520 obtains an off-chain data verification contract (for example, an off-chain data verification rule) in the cross-chain transaction protocol. The off-chain data verification contract is used to verify whether the cross-chain transaction data is valid, that is, verify whether the cross-chain transaction data is real. For example, the cross-chain transaction data includes an asset locking event, and the cross-chain relay device i may verify whether the asset locking event is executed on the first blockchain. In response to determining that the cross-chain transaction data is valid, the cross-chain relay device i may forward the cross-chain transaction data to the second blockchain (for example, send the data to the second node device maintaining the second blockchain). The cross-chain relay device i is any one of the N cross-chain relay devices 520, where i is a positive integer less than or equal to N. Each of the N cross-chain relay devices 520 may verify whether the cross-chain transaction data sent by the first node device 511 is valid, and in response to determining that the cross-chain transaction data is valid, forward the cross-chain transaction data to the second blockchain.

As shown in FIG. 5, the cross-chain relay device 521 determines that the cross-chain transaction data is valid and forwards the cross-chain transaction data to the second node device 531; the cross-chain relay device 522 determines that the cross-chain transaction data is invalid and does not forward the cross-chain transaction data; and the cross-chain relay device 523 determines that the cross-chain transaction data is valid and forwards the cross-chain transaction data to the second node device 531. In this manner, another cross-chain relay device of the N cross-chain relay devices 520 may also verify whether the cross-chain transaction data is valid, and forward the cross-chain transaction data to the second node device 531 in response to determining that the cross-chain transaction data is valid. When forwarding the cross-chain transaction data to the second blockchain, the cross-chain relay device i signs the cross-chain transaction data, and forwards the signed cross-chain transaction data to the second blockchain. The behavior of forwarding, by the cross-chain relay device i, the signed cross-chain transaction data to the second blockchain may be understood as a behavior for endorsing the cross-chain transaction data (that is, determining that the cross-chain transaction data is valid). When determining that the cross-chain transaction data is invalid (for example, the cross-chain transaction data is unreal), the cross-chain relay device i does not forward the cross-chain transaction data to the second blockchain. In this way, the N cross-chain relay devices verify whether the cross-chain transaction data is valid. This can implement decentralization and avoid cheating risk of centralization when a third-party cross-chain relay device forwards the cross-chain transaction data (for example, the third-party cross-chain relay device still forwards the cross-chain transaction data to the second blockchain when the cross-chain transaction data is invalid). In addition, the cross-chain relay device verifies whether the cross-chain transaction data is valid, to avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low.

As shown in FIG. 5, the second node device 531 may receive the cross-chain transaction data forwarded by the cross-chain relay device i. The cross-chain relay device i may be the cross-chain relay device 521, the cross-chain relay device 523, or the like. The second node device 531 counts a device quantity of cross-chain devices that send the cross-chain transaction data, and obtains a relay quantity threshold configured in a cross-chain service execution contract in a cross-chain transaction protocol. Further, the second node device 531 may verify whether the cross-chain transaction data is valid based on the device quantity of cross-chain devices that send the cross-chain transaction data and the relay quantity threshold. Specifically, the second node device 531 may compare the device quantity of cross-chain devices that send the cross-chain transaction data with the relay quantity threshold. In response to the device quantity being greater than or equal to the relay quantity threshold, it indicates that most cross-chain relay devices determine that the cross-chain transaction data is valid. Therefore, it is determined that the cross-chain transaction data is valid, and the cross-chain transaction data is executed. If the device quantity is less than the relay quantity threshold, it indicates that most cross-chain relay devices determine that the cross-chain transaction data is invalid. Therefore, it is determined that the cross-chain transaction data is invalid, and the cross-chain transaction data is not executed.

For example, the quantity of the N cross-chain relay devices is 5, and the relay quantity threshold is 3. If the second node device 531 receives the cross-chain transaction data sent by 4 or 5 cross-chain relay devices, it can be determined that the cross-chain transaction data is valid. If the second node device 531 receives the cross-chain transaction data sent by less than 3 cross-chain relay devices, it may be determined that the cross-chain transaction data is invalid. In this way, whether the cross-chain transaction data is valid is verified based on the device quantity of cross-chain relay devices that send the cross-chain transaction data. This can implement decentralization and avoid cheating risk of centralization caused by a third-party cross-chain relay device (for example, the third-party cross-chain relay device still forwards the cross-chain transaction data to the second blockchain when the cross-chain transaction data is invalid).

As can be seen, in this embodiment of the present disclosure, whether the target cross-chain service is legal is verified based on the on-chain service verification contract, and the target cross-chain service is executed only when the target cross-chain service is legal, thereby effectively improving cross-chain transaction security. In addition, the N cross-chain relay devices verify whether the cross-chain transaction data is valid. This can implement decentralization and avoid cheating risk of centralization caused by a third-party cross-chain relay device (for example, the third-party cross-chain relay device still forwards the cross-chain transaction data to the second blockchain when the cross-chain transaction data is invalid). Besides, this can improve cross-chain transaction efficiency, and avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low.

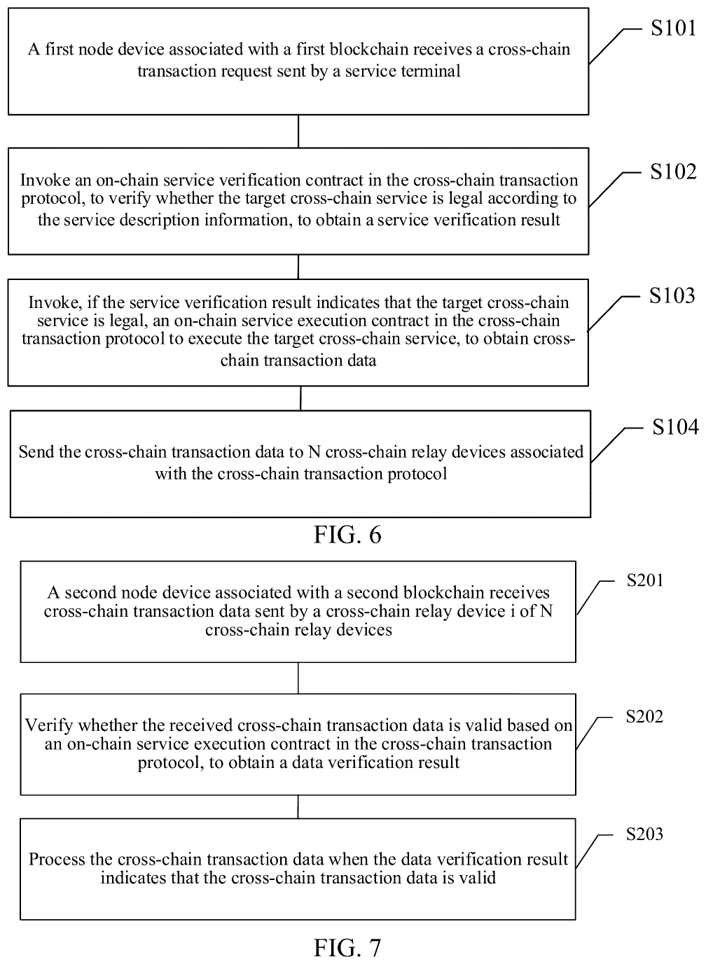

Further, FIG. 6 is a schematic flowchart of a data processing method based on a blockchain according to an embodiment of the present disclosure. As shown in FIG. 6, the method may be performed by a first node device maintaining a first blockchain in a blockchain network. The blockchain network may be the above core consensus network, the above service network, or other blockchain networks, which is not limited in this embodiment of the present disclosure. The first node device may be a server connected to the blockchain network, or may be a terminal device connected to the blockchain network. The first node device may be any node device of node devices that maintain the first blockchain. A specific form of the first node device is not limited herein. The method may include, but is not limited to, at least the following operations:

S101: A first node device associated with a first blockchain receives a cross-chain transaction request sent by a service terminal.

Specifically, the first node device associated with the first blockchain may be a node device maintaining the first blockchain. The first blockchain includes one or more blocks, and the first node device may be a device that generates a block and chains the generated block to the first blockchain. The first blockchain may belong to a first blockchain network. The first blockchain network may be the core consensus network in FIG. 3, or may be the service network in FIG. 3, or certainly may be another blockchain network. The service terminal may be a service node device maintaining the first blockchain, or may be a terminal device having data communication with a node device maintaining the first blockchain. The cross-chain transaction request includes service description information of a target cross-chain service associated with the first blockchain and a second blockchain, and both the first node device and a second node device that maintains the second blockchain satisfy a cross-chain transaction protocol.

Node devices in different blockchains all need to satisfy the cross-chain transaction protocol when performing a cross-chain transaction. Satisfying the cross-chain transaction protocol may refer to jointly formulating the cross-chain transaction protocol, allowing a cross-chain transaction protocol participant to join the cross-chain transaction protocol, and performing the cross-chain transaction based on the cross-chain transaction protocol. The cross-chain transaction protocol is a protocol for interaction and communication between different blockchains, resolves problems of isolation and interoperability between blockchains, and allows cross-chain data and asset transfer and exchange between different blockchains. The cross-chain transaction protocol includes a series of technologies and protocol specifications, including consensus algorithms, encryption technologies, smart contracts, inter-chain communications protocols, and the like. When performing a cross-chain transaction, node devices on different blockchains need to comply with rules of the series of technologies and protocol specifications included in the cross-chain transaction protocol.

The target cross-chain service is a cross-chain service between the first blockchain and the second blockchain. For example, when the target cross-chain service is transferring a digital asset from the first blockchain to the second blockchain, the service description information of the target cross-chain service may include an asset transfer-out account (a first account) on the first blockchain, a transfer-out asset amount, a transfer-out asset type, an identifier of the second blockchain, an asset transfer-in account (a second account) on the second blockchain, a service identifier of the target cross-chain service, and the like. For example, when the target cross-chain service is sharing status information on the first blockchain with the second blockchain, the service description information of the target cross-chain service may include an information attribute of the status information (for example, an owner of the status information such as asset status information of a digital asset on the first blockchain, or an unlocked status or a locked status), the identifier of the second blockchain, the service identifier of the target cross-chain service, and the like.

Specifically, a service object associated with the service terminal may initiate, by using a cross-chain service front-end provided in the service terminal, the cross-chain transaction request associated with the first blockchain and the second blockchain. The service object associated with the service terminal may be a possessing object or an operation object of a service terminal device. The cross-chain service front-end provided in the service terminal may be an application client, and is responsible for interacting with a cross-chain object (for example, the service object). For example, the cross-chain service front-end may be in a form of a webpage, an application (APP), a mini program, or the like. The service object may initiate, in a cross-chain transaction page provided by the cross-chain service front-end, the cross-chain transaction request associated with the first blockchain and the second blockchain. The cross-chain service front-end may send, to a cross-chain service back-end, the cross-chain transaction request initiated by the service object. The cross-chain service back-end may perform transaction encapsulation on the cross-chain transaction request, and send the cross-chain transaction request to the first blockchain. The first node device maintaining the first blockchain may obtain the cross-chain transaction request. In addition, the cross-chain service back-end may obtain an execution status or other information of the target cross-chain transaction, and return the execution status or other information of the target cross-chain transaction to the cross-chain service front-end, and the cross-chain service front-end may display the execution status or other information of the target cross-chain transaction. The cross-chain service back-end is a background server, and is mainly configured to provide data and blockchain transaction function support for the cross-chain service front-end.

S102: Invoke an on-chain service verification contract in the cross-chain transaction protocol, to verify whether the target cross-chain service is legal according to the service description information, to obtain a service verification result.

The first node device may invoke the on-chain service verification contract in the cross-chain transaction protocol. The on-chain verification contract may be a smart contract deployed on the first blockchain. The on-chain service verification contract is used to verify whether the cross-chain service is legal to verify whether the cross-chain service is a risky transaction (for example, an illegal asset transaction or a transaction that leaks important information (for example, privacy)). Specifically, The first node device may invoke the on-chain service verification contract, to verify whether the target cross-chain service is legal according to the service description information, to obtain the service verification result. The service verification result includes that the target cross-chain service is legal, or the target cross-chain service is illegal. The cross-chain service verification contract may be used to verify whether a cross-chain service submitted by a node device maintaining a blockchain is legal, and is deployed and managed by a verification mechanism in the cross-chain transaction protocol. For example, the verification mechanism sets content of the on-chain service verification contract and manages the on-chain service verification contract. In this way, whether the target cross-chain service is legal is verified based on the on-chain service verification contract, and an illegal target cross-chain service can be recognized, thereby effectively improving cross-chain transaction execution security.

Specifically, one embodiment of invoking, by the first node device, an on-chain service verification contract in the cross-chain transaction protocol, to verify whether the target cross-chain service is legal according to the service description information, to obtain a service verification result may include: invoking the on-chain service verification contract in the cross-chain transaction protocol, to obtain, from the service description information, first service attribute information indicating a service type of the target cross-chain service and second service attribute information indicating a service risk of the target cross-chain service; and determining a service verification type of the target cross-chain service according to the first service attribute information, and verifying whether the target cross-chain service is legal according to the service verification type and the second service attribute information, to obtain the service verification result.

Specifically, the first node device may invoke the on-chain service verification contract in the cross-chain transaction protocol, and obtain, from the service description information of the target cross-chain service, the first service attribute information used to indicate the service type of the target cross-chain service. The on-chain service verification contract that may be invoked by the first node device may be a smart contract deployed on the first blockchain. The first service attribute information may be used to indicate the service type of the target cross-chain service. For example, when the target cross-chain service is transferring a digital asset from the first blockchain to the second blockchain, the service description information of the target cross-chain service may include an asset transfer-out account (a first account) on the first blockchain, a transfer-out asset amount, a transfer-out asset type, an identifier of the second blockchain, an asset transfer-in account (a second account) on the second blockchain, a service identifier of the target cross-chain service, and the like, and the first service attribute information may include information such as the asset transfer-out account, the transfer-out asset amount, and the transfer-out asset type. Specifically, the first node device may determine the service verification type of the target cross-chain service according to the first service attribute information. Specifically, the first node device may determine the service verification type of the target cross-chain service based on the asset transfer-out account. The service verification type may include an on-chain service verification type and an off-chain service verification type.

The on-chain service verification type refers to verifying, on the first blockchain, whether the target cross-chain service is valid, and the off-chain service verification type may refer to verifying, by using an off-chain service verification service (for example, an off-chain service verification device), whether the target cross-chain service is valid. The on-chain service verification type refers to that the first node device invokes the on-chain service verification contract to verify whether the target cross-chain service is legal. The off-chain service verification type may refer to that the first node device sends the target cross-chain service to the off-chain service verification device by using the on-chain service verification contract, and the off-chain service verification device instructs a service verification object to verify whether the target cross-chain service is legal. In other words, the off-chain service verification type may be a manual verification type. When the target cross-chain service is a particular cross-chain service, it is difficult to determine, by using the on-chain service verification type, whether the target cross-chain service is legal. Therefore, accuracy of verifying whether the target cross-chain service is legal can be improved by using the off-chain service verification type.

In some embodiments, when the target cross-chain service is a cross-chain asset transfer service, the first service attribute information may include a transfer-out asset amount (that is, an asset amount of a to-be-transferred digital asset) specified by the target cross-chain service. One embodiment of determining, by the first node device, the service verification type of the target cross-chain service based on the first service attribute information may include: obtaining, by the first node device, a first asset amount threshold configured in the on-chain service verification contract, comparing the transfer-out asset amount with the first asset amount threshold, and if the asset transfer-out amount is greater than or equal to the first asset amount threshold, determining that the service verification type of the target cross-chain service is the off-chain service verification type. When the asset transfer-out amount is greater than or equal to the first asset amount threshold, risk of illegal asset transfer is prone to occur. Therefore, whether the target cross-chain service is legal is verified by using the off-chain service verification type, thereby improving cross-chain asset transfer security. Certainly, if the asset transfer-out amount is less than the first asset amount threshold, the service verification type of the target cross-chain service may be determined as the on-chain service verification type, thereby improving efficiency of verifying whether the target cross-chain service is legal.

In some embodiments, when the target cross-chain service is a cross-chain asset transfer service, the first service attribute information may include an asset transfer-out account, and one embodiment of determining, by the first node device, the service verification type of the target cross-chain service according to the first service attribute information may include: obtaining, by the first node device, a total asset amount corresponding to the asset transfer-out account, obtaining a second asset amount threshold configured in the on-chain service verification contract, comparing the total asset amount of the asset transfer-out account with the second asset amount threshold, and if the total asset amount of the asset transfer-out account is greater than or equal to the asset amount threshold, determining that the service verification type of the target cross-chain service is the off-chain service verification type. When the total asset amount of the asset transfer-out account is greater than or equal to the asset amount threshold, risk of illegal asset transfer is prone to occur. Therefore, whether the target cross-chain service is legal is verified by using the off-chain service verification type, thereby improving cross-chain asset transfer security. Certainly, if the total asset amount of the asset transfer-out account is less than the asset amount threshold, the service verification type of the target cross-chain service may be determined as the on-chain service verification type, thereby improving efficiency of verifying whether the target cross-chain service is legal.

In some embodiments, when the target cross-chain service is a cross-chain asset transfer service, the first service attribute information may include an asset transfer-out account, and one embodiment of determining, by the first node device, the service verification type of the target cross-chain service according to the first service attribute information may include: obtaining, by the first node device, an asset transfer quantity corresponding to the asset transfer-out account and obtaining a transfer quantity threshold configured in the on-chain service verification contract, comparing the asset transfer quantity corresponding to the asset transfer-out account with the transfer quantity threshold, and if the asset transfer quantity corresponding to the asset transfer-out account is greater than or equal to the transfer quantity threshold, determining that the service verification type of the target cross-chain service is the off-chain service verification type. When the asset transfer quantity corresponding to the asset transfer-out account is greater than or equal to the transfer quantity threshold, it indicates that a service object corresponding to the asset transfer-out account frequently transfers assets, and risk of illegal asset transfer is prone to occur. Therefore, whether the target cross-chain service is legal is verified by using the off-chain service verification type, thereby improving cross-chain asset transfer security. Certainly, if the asset transfer quantity corresponding to the asset transfer-out account is less than the transfer quantity threshold, the service verification type of the target cross-chain service may be determined as the on-chain service verification type, thereby improving efficiency of verifying whether the target cross-chain service is legal.

Certainly, the first node device may determine the service verification type of the target cross-chain service comprehensively based on the first service attribute information. For example, when the target cross-chain service is a cross-chain asset transfer service, the first node device may determine the service verification type of the target cross-chain service comprehensively based on information such as an asset transfer-out account, a transfer-out asset amount, and a transfer-out asset type. Further, the first node device may obtain, from the service description information, the second service attribute information indicating the service risk of the target cross-chain service. For example, when the service description information of the target cross-chain service includes information such as an asset transfer-out account (a first account) on the first blockchain, a transfer-out asset amount, a transfer-out asset type, an identifier of the second blockchain, an asset transfer-in account (a second account) on the second blockchain, and a service identifier of the target cross-chain service, the second service attribute information may include information such as the asset transfer-out account, the transfer-out asset amount, the transfer-out asset type, and the asset transfer-in account. The first node device may verify whether the target cross-chain service is legal according to the service verification type and the second service attribute information, to obtain the service verification result.

The second service attribute information may include one or more pieces of information that is configured for legality verification and that is in the service description information of the target cross-chain service.

In some embodiments, one embodiment of verifying, by the first node device, whether the target cross-chain service is legal according to the service verification type and the second service attribute information, to obtain the service verification result may include: invoking the on-chain service verification contract in response to the service verification type being an on-chain service verification type, to obtain a terminal risk level of the service terminal according to the second service attribute information, and obtain a data risk level of service data specified by the target cross-chain service; and generating, in response to the terminal risk level being less than a first level threshold and the data risk level is less than a second level threshold, the service verification result for indicating that the target cross-chain service is legal.

Specifically, the first node device may invoke the on-chain service verification contract if the service verification type is the on-chain service verification type, and obtain the terminal risk level of the service terminal according to the second service attribute information. Specifically, the first node device may invoke a terminal identifier list configured in the on-chain service verification contract, where the terminal identifier list includes one or more terminal identifiers having relatively high risk levels (for example, the risk level is greater than or equal to the first level threshold), detect whether a terminal identifier of the service terminal is in the terminal identifier list, and if the terminal identifier of the service terminal is in the terminal identifier list, determine that the terminal risk level is relatively high (for example, determine that the terminal risk level of the service terminal is greater than or equal to the first level threshold). If the terminal identifier of the service terminal is in the terminal identifier list, a history transaction request submission record of the service terminal is obtained, and the terminal risk level of the service terminal is determined based on the history transaction request record (for example, whether a risky transaction request (that is, an illegal transaction request) is submitted for multiple times). Certainly, the first node device may obtain processing permission of the service terminal for the target cross-chain service. For example, when the target cross-chain service is a cross-chain asset transfer service, the first node device detects whether the service object corresponding to the service terminal has asset processing permission for the asset transfer-out account. If the service terminal has no processing permission for the target cross-chain service, it is determined that the terminal risk level of the service terminal device is greater than or equal to the first level threshold.

In addition, the first node device may obtain the data risk level of the service data specified by the target cross-chain service. The service data specified by the target cross-chain service may be a service object or a service status of the target cross-chain service. If the target cross-chain service is a cross-chain asset transfer service, the service data specified by the target cross-chain service may be a digital asset that needs to be transferred out. When the target cross-chain service is a cross-chain information sharing service, the service data specified by the target cross-chain service may be information that needs to be transferred out, or the like. The first node device obtains a data source of the service data specified by the target cross-chain service, and determines, based on the data source, the data risk level of the service data specified by the target cross-chain service. If the service data specified by the target cross-chain service is important information and cannot be transferred, it may be determined that the data risk level of the service data specified by the target cross-chain service is greater than or equal to the second level threshold. If the source of the service data specified by the target cross-chain service is abnormal (for example, an illegal asset, that is, an asset that is not generated according to a normal asset generation process), it may be determined that the data risk level of the service data specified by the target cross-chain service is greater than or equal to the second level threshold.

Further, if determining that the terminal risk level is less than the first level threshold and the data risk level is less than the second level threshold, the first node device generates the service verification result for indicating that the target cross-chain service is legal. Certainly, if determining that the terminal risk level is greater than or equal to the first level threshold and the data risk level is greater than or equal to the second level threshold, the first node device generates the service verification result for indicating that the target cross-chain service is illegal.

In some embodiments, one embodiment of verifying, by the first node device, whether the target cross-chain service is legal according to the service verification type and the second service attribute information, to obtain the service verification result may include: invoking the on-chain service verification contract in response to the service verification type being an off-chain service verification type, to send the second service attribute information to an off-chain service verification device, where the off-chain service verification device is configured to instruct a service verification object to perform a verification operation on the target cross-chain service based on the second service attribute information, receiving an operation result of the verification operation returned by the off-chain service verification device, and generating the service verification result of the target cross-chain service according to the operation result.

Specifically, if the service verification type is the off-chain service verification type, the first node device may invoke the on-chain service verification contract, to send the second service attribute information to the off-chain service verification device. The off-chain service verification device may be a server, or may be a terminal device. The off-chain service verification device may instruct the service verification object to perform a verification operation on the target cross-chain service based on the second service attribute information. For example, the off-chain service verification device may output the second service attribute information, to instruct the service verification object to verify whether the target cross-chain service is legal. The off-chain service verification device may obtain an operation result of the verification operation performed by the service verification object on the target cross-chain service. The operation result may be that the service object determines that the target cross-chain service is illegal or the target cross-chain service is legal. The off-chain service verification device may return the operation result to the on-chain service verification contract. The on-chain service verification contract may be used to generate the service verification result of the target cross-chain service based on the operation result. In this way, the service verification object verifies whether the target cross-chain service is legal, to resolve the problem that the on-chain service verification contract cannot verify whether the target cross-chain service is legal. Besides, verification accuracy can also be improved.

S103: Invoke, in response to the service verification result indicating that the target cross-chain service is legal, an on-chain service execution contract in the cross-chain transaction protocol to execute the target cross-chain service, to obtain cross-chain transaction data.

Specifically, the first node device invokes, in response to the service verification result indicating that the target cross-chain service is legal, the on-chain service execution contract in the cross-chain transaction protocol to execute the target cross-chain service, to obtain the cross-chain transaction data. The on-chain service execution contract invoked by the first node device may be a smart contract deployed on the first blockchain. The on-chain service execution contract may be a cross-chain bridge contract. The received target cross-chain service is processed based on a service processing rule specified in the cross-chain bridge contract and a cross-chain communication protocol. As can be seen, in this embodiment of the present disclosure, the target cross-chain service is executed only when the target cross-chain service is valid. This can improve security of executing the cross-chain service and can prevent an illegal cross-chain service from being executed.

In some embodiments, for example, the target cross-chain service is a cross-chain asset transfer service. The target cross-chain service is used to instruct to transfer a digital asset of a target asset type. One embodiment of invoking, by the first node device, the on-chain service execution contract in the cross-chain transaction protocol to execute the target cross-chain service, to obtain the cross-chain transaction data may include: invoking the on-chain service execution contract in the cross-chain transaction protocol in response to the service verification result indicating that the target cross-chain service is legal, to determine, in an asset custody contract set on the first blockchain, an asset custody contract matching the target asset type as a first asset custody contract; and determine, in an asset processor set on the first blockchain, an asset processor matching the target asset type as a first asset processor; and executing the target cross-chain service according to the first asset custody contract and the first asset processor, to obtain the cross-chain transaction data.

Specifically, the first node device may invoke the on-chain service execution contract in the cross-chain transaction protocol if determining that the service verification result indicates that the target cross-chain service is legal, and determine, in the asset custody contract set on the first blockchain, the asset custody contract matching the target asset type as the first asset custody contract. The asset custody contract on the first blockchain may be a smart contract deployed on the first blockchain, and may automatically lock a specified digital asset or release a specified digital asset. The asset custody contract set on the first blockchain includes one or more asset custody contracts. For example, the asset custody contract set on the first blockchain may include an asset custody contract A1, an asset custody contract A2, and the like. One asset custody contract in the asset custody contract set on the first blockchain is used to lock a digital asset of one asset type, thereby facilitating management of digital assets of different asset types.

Further, the first node device may determine, in the asset processor set on the first blockchain, the asset processor matching the target asset type as the first asset processor. The asset processor set on the first blockchain includes one or more asset processors. For example, the asset processor set on the first blockchain may include an asset processor B1 and an asset processor B2. A cross-chain asset contract is deployed on each asset processor in the asset processor set, and the asset processor may perform asset processing based on the cross-chain asset contract. One asset processor in the asset processor set on the first blockchain is configured to process a digital asset of one asset type, thereby facilitating management of digital assets of different asset types. The first node device may execute the target cross-chain service according to the first asset custody contract and the first asset processor, to obtain the cross-chain transaction data.

In some embodiments, the digital asset of the target asset type belongs to the first account in the first blockchain, and an amount of the digital asset is the target asset amount. That is, the target cross-chain service is used to instruct to transfer the digital asset of the target asset type and the target asset amount from the first account on the first blockchain to the second blockchain. One embodiment of executing, by the first node device, the target cross-chain service according to the first asset custody contract and the first asset processor, to obtain the cross-chain transaction data may include: invoking the first asset processor to lock the digital asset of the target asset type and the target asset amount in the first account to the first asset custody contract; generating an asset locking event that indicates that the digital asset of the target asset type and the target asset amount has been locked to the first asset custody contract; generating a chaining request for the asset locking event, and sending the chaining request to a consensus node of the first blockchain; where the consensus node of the first blockchain is configured to perform consensus on the asset locking event, to obtain a consensus result; and receiving the consensus result returned by the consensus node of the first blockchain, and generating the cross-chain transaction data of the target cross-chain service according to the consensus result.

Specifically, the first node device may invoke the first asset processor by using the on-chain service execution contract, to lock the digital asset of the target asset type and the target asset amount in the first account to the first asset custody contract. The first asset custody contract includes a public account of the target asset type. The first node device may transfer the digital asset of the target asset type and the target asset amount in the first account to the public account of the target asset type in the first asset custody contract, to lock the digital asset of the target asset type and the target asset amount in the first account. As can be seen, when the target cross-chain service is a cross-chain asset transfer service, the asset processor on the first blockchain may lock a to-be-transferred digital asset (for example, the digital asset of the target asset type and the target asset amount in the first account) to the asset custody contract on the first blockchain. In this way, a cross-chain service provided by the on-chain service execution contract and an asset custody service provided by the asset custody contract can be independent of each other, and the on-chain service execution contract cannot arbitrarily operate a pledged asset of the target cross-chain service in a cross-chain process, thereby further improving asset security. The existence of the asset custody contract makes a cross-chain service provider and an asset custody provider independent of each other, and in an on-chain service, a pledged asset of the target cross-chain service in a cross-chain process cannot be arbitrarily operated, thereby further improving asset security.

Further, the first node device may generate an asset locking event that indicates that the digital asset of the target asset type and the target asset amount in the first account has been locked to the first asset custody contract. The first node device may generate a chaining request for the asset locking event, and send the chaining request to a consensus node of the first blockchain. The consensus node of the first blockchain may perform consensus on the asset locking event, to detect whether the asset locking event is valid (that is, whether the first node device has locked the digital asset of the target asset type and the target asset amount in the first account to the first asset custody contract), to obtain a consensus result, and return the consensus result to the first node device. Specifically, the first node device may receive the consensus result returned by the consensus node of the first blockchain, and generate the cross-chain transaction data of the target cross-chain service according to the consensus result.

In some embodiments, the target cross-chain service is further used to instruct to transfer the digital asset of the target asset type and the target asset amount to a second account on the second blockchain. One embodiment of generating, by a computer device, the cross-chain transaction data of the target cross-chain service according to the consensus result may include: chaining the asset locking event to the first blockchain in response to the consensus result indicating that the consensus on the asset locking event succeeds; generating an asset release request, where the asset release request is used to instruct the second node device to release the digital asset of the target asset type and the target asset amount from a second asset custody contract to the second account, where the second asset custody contract is an asset custody contract that is associated with the target asset type and that is on the second blockchain; and determining the asset locking event and the asset release request as the cross-chain transaction data of the target cross-chain service.

Specifically, the first node device may chain the asset locking event to the first blockchain in response to the consensus result indicating that the consensus on the asset locking event succeeds. Specifically, the first node device may generate a target block about the asset locking event, and add the target block to the first blockchain. In addition, the first node device may generate the asset release request, where the asset release request is used to instruct the second node device to release the digital asset of the target asset type and the target asset amount from the second asset custody contract to the second account. The second asset custody contract is an asset custody contract that is associated with the target asset type and that is on the second blockchain. The asset locking event and the asset release request are determined as the cross-chain transaction data of the target cross-chain service.

When a third node device maintaining a third blockchain receives an asset transfer service used to transfer a digital asset of a target asset type from the third blockchain to the first blockchain, the third node device may verify whether the asset transfer service is legal. When the asset transfer service is legal, the third node device may lock the digital asset of the target asset type on the third blockchain by using an asset custody contract and an asset processor that are associated with the target asset type and that are on the third blockchain. Meanwhile, the third node device may generate a release request used to instruct the first node device to release the digital asset of the target asset type to the first account. After receiving the release request for releasing the digital asset of the target asset type to the first account, the first node device may determine, in the asset custody contract set on the first blockchain, an asset custody contract matching the target asset type, that is, the first asset custody contract, and determine, in the asset processor set on the first blockchain, an asset processor matching the target asset type, that is, the first asset processor. Further, the digital asset of the target asset type is released from the first asset custody contract to the first account, that is, the digital asset of the target asset type is transferred from the public account in the first asset custody contract to the first account.

In some embodiments, the target cross-chain service may be a cross-chain information sharing service, a cross-chain transaction transfer service, or the like. One embodiment of invoking, by the first node device, an on-chain cross-chain contract in the cross-chain transaction protocol to execute the target cross-chain service, to obtain cross-chain transaction data of the target cross-chain service may include: invoking a general-purpose message processor on the first blockchain based on the on-chain service execution contract in the cross-chain transaction protocol in response to the service verification result indicating that the target cross-chain service is legal and the target cross-chain service is of a non-asset-transaction type; obtaining, from the first blockchain by using the general-purpose message processor, the service data specified by the target cross-chain service; and determining the service data specified by the target cross-chain service as the cross-chain transaction data of the target cross-chain service.

Specifically, in response to the service verification result indicating that the target cross-chain service is legal, and the target cross-chain service is of a non-asset-transaction type (for example, the target cross-chain service is a cross-chain information sharing service, a cross-chain transaction transfer service, or the like), the first node device may invoke a general-purpose message processor on the first blockchain by using the on-chain service execution contract in the cross-chain transaction protocol. A cross-chain application contract is deployed in the general-purpose message processor, to process the cross-chain service of the non-asset-transaction type. The first node device may obtain, from the first blockchain by using the message processor, the service data specified by the target cross-chain service. For example, when the target cross-chain service is a cross-chain information sharing service, the service data specified by the target cross-chain service is information that needs to be shared, for example, status information (for example, a locked status or an unlocked status) of an asset, or execution status information (for example, executed, being executed, or not executed) of a service. If the target cross-chain service is a cross-chain transaction transfer service, the service data specified by the target cross-chain service is a transaction that needs to be transferred. That is, a to-be-executed transaction on the first blockchain may be transferred to another blockchain (for example, the second blockchain). In this way, performance can be extended and load of the first blockchain can be reduced. The first node device may determine the service data specified by the target cross-chain service as the cross-chain transaction data of the target cross-chain service.

S104: Send the cross-chain transaction data to N cross-chain relay devices associated with the cross-chain transaction protocol.

Specifically, the first node device may send the cross-chain transaction data to N cross-chain relay devices associated with the cross-chain transaction protocol, where N is a positive integer greater than 1, and i is a positive integer less than or equal to N. The first node device may send the cross-chain transaction data to each of the N cross-chain relay devices. After receiving the cross-chain transaction data sent by the first node device, the cross-chain relay device i of the N cross-chain relay devices may obtain the off-chain data verification contract in the cross-chain transaction protocol (for example, an off-chain data verification rule that is specified in the cross-chain transaction protocol and that is used by the cross-chain relay device to verify whether the cross-chain transaction data is valid). Further, the cross-chain relay device i may verify whether the cross-chain transaction data is valid based on the off-chain data verification contract, to verify whether the first node device has locked the digital asset of the target asset type and the target asset amount in the first account on the first blockchain. If determining that the cross-chain transaction data is valid (that is, the first node device has locked the digital asset of the target asset type and the target asset amount in the first account on the first blockchain), the cross-chain relay device i sends the cross-chain transaction data to the second node device.

The cross-chain relay device i is any one of the N cross-chain relay devices. Each of the N cross-chain relay devices verifies whether the cross-chain transaction data is valid, and in response to determining that the cross-chain transaction data is valid, forwards the cross-chain transaction data to the second node device. Certainly, when determining that the cross-chain transaction data is illegal, the cross-chain relay device does not forward the cross-chain transaction data to the second node device. In this way, the N cross-chain relay devices verify whether the cross-chain transaction data is valid. This can implement decentralization and avoid cheating risk of centralization when a third-party cross-chain relay device forwards the cross-chain transaction data (for example, the third-party cross-chain relay device still forwards the cross-chain transaction data to the second node device when the cross-chain transaction data is invalid, and as a result, the second node device executes the risky cross-chain transaction data). Besides, this can improve cross-chain transaction efficiency, and avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low.

The on-chain service execution contract in the cross-chain transaction protocol may add, delete, modify, and check identities of the N cross-chain relay devices. Specifically, the on-chain service execution contract may manage qualification of joining the N cross-chain relay devices. For example, if a device Q1 requests to be added to the N cross-chain relay devices, the on-chain service execution contract may review qualification of the device Q1. When the review of the device Q1 succeeds, the device Q1 is added to the N cross-chain relay devices and is configured to verify whether the cross-chain transaction data is valid. Specifically, the on-chain service execution contract may delete an unqualified cross-chain relay device from the N cross-chain relay devices (that is, the unqualified cross-chain relay device is removed from the N cross-chain relay devices). For example, when a cross-chain relay device j of the N cross-chain relay devices forwards illegal cross-chain transaction data for multiple times, it may be determined that the cross-chain relay device j is unqualified, and the on-chain service execution contract may remove the cross-chain relay device j from the N cross-chain relay devices. Specifically, the on-chain service execution contract may modify the off-chain data verification contract used by the cross-chain relay device to verify whether the cross-chain transaction data is valid, or may query information, for example, a history verification record of cross-chain transaction data of the N cross-chain relay devices or a device status of the cross-chain relay device. In addition, the on-chain service execution contract may manage a relay quantity threshold M of the cross-chain relay devices. If M of the N cross-chain relay devices endorse the cross-chain transaction data (that is, forward the cross-chain transaction data), it may be determined that the cross-chain transaction data is valid in the on-chain service execution contract of the second node device, and the cross-chain transaction data is executed (that is, it is considered that the cross-chain transaction data succeeds verification and continues to be executed).

The on-chain service execution contract on the first blockchain may record the service description information of the target cross-chain service. For example, when the target cross-chain service is a cross-chain asset transfer service, the on-chain service execution contract on the first blockchain may record a submitting service terminal (or a service object initiating the cross-chain transaction request), an asset amount (that is, an asset amount of a to-be-transferred digital asset), an asset type (that is, an asset type of the to-be-transferred digital asset), a target chain identifier (an identifier of a blockchain to which the digital asset is to be transferred, for example, a chain identifier of the second blockchain), a target user address (an account to which the digital asset is to be transferred), a transaction sequence number (that is, a service identifier of the target cross-chain service), and the like.

The on-chain service execution contract on the second blockchain may record an endorsing status of the target cross-chain service (that is, a status in which the cross-chain relay device forwards the cross-chain transaction data), and status information of the target cross-chain service. The status information of the target cross-chain service may include one or more of an inactivated status, an activated status, a verified status, an execution proceeding status, an execution completion status, a cancelled status, and the like. The inactivated status may mean that no cross-chain relay device currently endorses the cross-chain transaction data (that is, forwards the cross-chain transaction data to the second node device). The activated status may mean that a cross-chain relay device currently has endorsed the cross-chain transaction data. The verified status means that cross-chain relay devices whose quantity is greater than or equal to the relay quantity threshold M currently have endorsed the cross-chain transaction data. The execution proceeding status may mean that the second node device is processing the cross-chain transaction data. The execution completion status may mean that the second node device completes execution of the cross-chain transaction data. The cancelled status may mean that the second node device cancels execution of the cross-chain transaction data.

The second node device may receive the cross-chain transaction data forwarded by the cross-chain relay device i, verify whether the received cross-chain transaction data is valid, and process the received cross-chain transaction data in response to determining that the cross-chain transaction data is valid.

The embodiments of the present disclosure provide a cross-chain transaction protocol. The cross-chain transaction protocol includes an on-chain part and an off-chain part. The on-chain part includes the on-chain service verification contract (used to verify whether a cross-chain service is legal), the on-chain service execution contract (used to execute a cross-chain service), and an access condition (that is, a risk management rule) for a node device corresponding to a blockchain to join a cross-chain transaction. The off-chain part includes the off-chain data verification contract used by a cross-chain relay device to verify whether cross-chain transaction data that needs to be forwarded is valid. Cross-chain service processing can be automatically implemented by using these contracts in the cross-chain transaction protocol, thereby improving cross-chain service processing efficiency and security. During actual application, when receiving the cross-chain transaction request sent by the service terminal, the first node device invokes the on-chain service verification contract in the cross-chain transaction protocol, to verify whether the target cross-chain service in the cross-chain transaction request is legal. The first node device invokes, if the target cross-chain service is legal, the on-chain service execution contract in the cross-chain transaction protocol to execute the target cross-chain service, to obtain the cross-chain transaction data. As can be seen, whether the target cross-chain service is legal is verified based on the on-chain service verification contract, and the target cross-chain service is executed only when the target cross-chain service is legal, thereby effectively improving cross-chain service processing security.

Further, the first node device may send the cross-chain transaction data to the N cross-chain relay devices associated with the cross-chain transaction protocol. The cross-chain relay device i of the N cross-chain relay devices is configured to transmit the cross-chain transaction data to the second node device in response to determining that the cross-chain transaction data is valid based on the off-chain data verification contract in the cross-chain transaction protocol. In this way, the N cross-chain relay devices verify whether the cross-chain transaction data is valid, and forward valid cross-chain transaction data. This can implement decentralization and avoid cheating risk of centralization when a third-party cross-chain relay device forwards the cross-chain transaction data (for example, the third-party cross-chain relay device still forwards the cross-chain transaction data to the second blockchain when the cross-chain transaction data is invalid). In addition, the cross-chain relay device verifies whether the cross-chain transaction data is valid, to avoid that a large amount of ledger structure data in the first blockchain is sent to the second blockchain (to verify, on the second blockchain, whether the cross-chain transaction data is valid based on the large amount of ledger structure data), and consequently cross-chain service processing costs are relatively high and cross-chain service processing efficiency is relatively low. Therefore, cross-chain service processing costs can be reduced and cross-chain service processing efficiency can be improved. The second node device processes the received cross-chain transaction data only in response to determining that the cross-chain transaction data is valid, thereby improving cross-chain transaction security.

Further, FIG. 7 is a schematic flowchart of a data processing method based on a blockchain according to an embodiment of the present disclosure. As shown in FIG. 7, the method may be performed by a second node device maintaining a second blockchain in a blockchain network. The blockchain network may be the above core consensus network, the above service network, or other blockchain networks, which is not limited in this embodiment of the present disclosure. The second node device may be a server connected to the blockchain network, or may be a terminal device connected to the blockchain network. The second node device may be any node device of node devices that maintain the second blockchain. A specific form of the second node device is not limited herein. The method may include, but is not limited to, at least the following operations:

S201: A second node device associated with a second blockchain receives cross-chain transaction data sent by a cross-chain relay device i of N cross-chain relay devices.

Specifically, the second node device associated with the second blockchain may be a node device maintaining the second blockchain, and the second node device may be any node device of node devices maintaining the second blockchain. The second blockchain includes one or more blocks, and the second node device may be a device that generates a block and chains the generated block to the second blockchain. The second blockchain may belong to a second blockchain network. The second blockchain network may be the core consensus network in FIG. 3, or may be the service network in FIG. 3, or certainly may be another blockchain network. The first blockchain network may be the same as or different from the first blockchain network to which the first blockchain belongs. Second node devices all satisfy the cross-chain transaction protocol, that is, the cross-chain transaction protocol is deployed on the second blockchain, and the node device maintaining the second blockchain can perform a cross-chain transaction based on the cross-chain transaction protocol.

The cross-chain transaction data is generated by the first node device by executing a target cross-chain service when determining that the target cross-chain service is legal based on an on-chain service verification contract in a cross-chain transaction protocol, and is forwarded by the first node device to the N cross-chain relay devices, and a cross-chain relay device i is configured to transmit the cross-chain transaction data to the second node device in response to determining that the cross-chain transaction data is valid based on an off-chain data verification contract in the cross-chain transaction protocol. In this way, the N cross-chain relay devices verify whether the cross-chain transaction data is valid. This can implement decentralization and avoid cheating risk of centralization when a third-party cross-chain relay device forwards the cross-chain transaction data (for example, the third-party cross-chain relay device still forwards the cross-chain transaction data to the second node device when the cross-chain transaction data is invalid, and as a result, the second node device executes the risky cross-chain transaction data). Besides, this can improve cross-chain transaction efficiency, and avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low. The target cross-chain service is associated with a first blockchain maintained by the first node device and a second blockchain, both the first node device and the second node device satisfy the cross-chain transaction protocol, Nis an integer greater than 1, and i is an integer less than or equal to N. In this embodiment of the present disclosure, specific content of the cross-chain transaction data in operation S201 can be found in the content of operation S101 to operation S104 in FIG. 6. Details are not described again in the embodiments of the present disclosure.

S202: Verify whether the received cross-chain transaction data is legal based on an on-chain service execution contract in the cross-chain transaction protocol, to obtain a data verification result.

Specifically, the second node device may verify whether the received cross-chain transaction data is valid based on the on-chain service execution contract in the cross-chain transaction protocol, to obtain the data verification result. The on-chain service execution contract invoked by the second node device may be a smart contract deployed on the second blockchain. A node device maintaining the second blockchain invokes the on-chain service execution contract deployed on the second blockchain, to perform a cross-chain transaction. The data verification result may be used to indicate that the received cross-chain transaction data is valid, or may be used to indicate that the received cross-chain transaction data is invalid.

In some embodiments, the cross-chain transaction data includes an asset locking event used to indicate that a digital asset of a target asset type and a target asset amount in the first account on the first blockchain has been locked. One embodiment of verifying, by the second node device, whether the received cross-chain transaction data is legal based on an on-chain service execution contract in the cross-chain transaction protocol, to obtain a data verification result may include: obtaining a relay quantity threshold configured in the on-chain service execution contract in the cross-chain transaction protocol, and counting a device quantity of cross-chain relay devices that send the cross-chain transaction data; comparing the relay quantity threshold with the device quantity; and determining that the asset locking event is valid in response to the device quantity being greater than or equal to the relay quantity threshold, and generating the data verification result for indicating that the cross-chain transaction data is valid.

Specifically, the second node device obtains the relay quantity threshold configured in the on-chain service execution contract in the cross-chain transaction protocol. The relay quantity threshold may be determined based on N of the N cross-chain relay devices. For example, the relay quantity threshold may be a threshold greater than N/2 and less than or equal to N. For example, when the quantity of the N cross-chain relay devices is 5, the relay quantity threshold may be 3, 4, or 5. The relay quantity threshold may be configured in the on-chain service execution contract in the cross-chain transaction protocol, and the on-chain service execution contract may manage the N cross-chain relay devices. The second node device may count a device quantity of cross-chain relay devices sending the cross-chain transaction data, and compare the relay quantity threshold with the device quantity. In response to the device quantity being greater than or equal to the relay quantity threshold, it indicates that most cross-chain relay devices determine that the cross-chain transaction data is valid, and the second node device determines that the asset locking event is valid, and generates the data verification result used to indicate that the cross-chain transaction data succeeds verification. In this way, the second node device determines that the cross-chain transaction data is valid only when determining that the device quantity is greater than or equal to the relay quantity threshold. This can implement decentralization and avoid cheating risk of centralization when a third-party cross-chain relay device forwards the cross-chain transaction data (for example, the third-party cross-chain relay device still forwards the cross-chain transaction data to the second node device when the cross-chain transaction data is invalid, and as a result, the second node device executes the risky cross-chain transaction data).

If the device quantity is less than the relay quantity threshold, it indicates that most cross-chain relay devices determine that the cross-chain transaction data is invalid. Therefore, it is determined that the asset locking event is invalid, and the data verification result used to indicate that the cross-chain transaction data is invalid is generated. In this case, the second node device does not execute the cross-chain transaction data. In this way, cross-chain transaction security can be improved.

S203: Process the cross-chain transaction data when the data verification result indicates that the cross-chain transaction data is valid.

Specifically, when the data verification result indicates that the cross-chain transaction data is valid, the second node device may execute the cross-chain transaction data, to implement the cross-chain transaction between the first blockchain and the second blockchain. In addition, the cross-chain transaction data is executed only when it is determined that the cross-chain transaction data is valid, thereby improving cross-chain transaction security.

In some embodiments, one embodiment of processing, by the second node device, the cross-chain transaction data when the data verification result indicates that the cross-chain transaction data succeeds verification may include: invoking the on-chain service verification contract in the cross-chain transaction protocol when the data verification result indicates that the cross-chain transaction data is valid, to determine a data verification type of the cross-chain transaction data; verifying whether data processing of the cross-chain transaction data is risky according to the data verification type, to obtain a risk verification result; and processing the cross-chain transaction data when the risk verification result indicates that the cross-chain transaction data is not risky data.

Specifically, when the data verification result indicates that the cross-chain transaction data is valid, the second node device may invoke the on-chain service verification contract in the cross-chain transaction protocol. The on-chain service verification contract invoked by the second node device may be a smart contract deployed on the second blockchain. Node devices maintaining the second blockchain may all invoke the on-chain service verification contract to verify whether a service or data is risky (that is, whether the service or the data is legal). The on-chain service verification contract may be deployed on different blockchains on which a cross-chain transaction needs to be performed, to verify whether a service or data is risky (that is, whether the service or the data is legal). The second node device may invoke the on-chain service verification contract in the cross-chain transaction protocol, to determine the data verification type of the cross-chain transaction data.

The data verification type may be an on-chain data verification type and an off-chain data verification type. The on-chain data verification type refers to verifying whether the cross-chain transaction data is risky by using the on-chain service verification contract. The off-chain data verification type may refer to that the cross-chain transaction data is sent to an off-chain service verification device by using the on-chain service verification contract, and the off-chain service verification device instructs a service verification object to verify whether the cross-chain transaction data is risky (for example, manual verification). The second node device may verify whether the cross-chain transaction data is risky based on the data verification type, to obtain a risk verification result, and process the cross-chain transaction data when the risk verification result indicates that the cross-chain transaction data is not risky data. In this way, security of processing the cross-chain transaction data can be improved.

For example, the cross-chain transaction data includes an asset release request, and the asset release request is used to instruct the second node device to release the digital asset of the target asset type and the target asset amount to a second account of the second blockchain. The second node device may detect whether the second account belongs to an illegal account set, and if the second account belongs to the illegal account set, may determine that the cross-chain transaction data is risky data, and does not process the cross-chain transaction data. Alternatively, the second node device may obtain a possessing object of the second account, detect an object risk level of the possessing object based on a transaction record of the possessing object, and if the object risk level of the possessing object is greater than or equal to a third risk level, may determine that the cross-chain transaction data is risky data, and does not process the cross-chain transaction data.

In some embodiments, the cross-chain transaction data includes an asset release request, and the asset release request is used to instruct the second node device to release the digital asset of the target asset type and the target asset amount to a second account of the second blockchain. One embodiment of processing, by the second node device, the cross-chain transaction data when the risk verification result indicates that the cross-chain transaction data is not risky data may include: determining, in an asset custody contract set on the second blockchain, an asset custody contract matching the target asset type as a second asset custody contract when the risk verification result indicates that the cross-chain transaction data is not risky data; determining, in an asset processor set on the second blockchain, an asset processor matching the target asset type as a second asset processor; and invoking the second asset processor to release the digital asset of the target asset type and the target asset amount from the second asset custody contract to the second account.

Specifically, the second node device may determine, in the asset custody contract set on the second blockchain, the asset custody contract matching the target asset type as the second asset custody contract when the risk verification result indicates that the cross-chain transaction data is not risky data. Similarly, the asset custody contract on the second blockchain may be a smart contract deployed on the second blockchain, and may automatically lock a specified digital asset or release a specified digital asset. The asset custody contract set on the second blockchain includes one or more asset custody contracts. For example, the asset custody contract set on the second blockchain may include an asset custody contract A3, an asset custody contract A4, and the like. One asset custody contract in the asset custody contract set on the second blockchain is used to lock a digital asset of one asset type, thereby facilitating management of digital assets of different asset types. The asset custody contract set on the first blockchain and the asset custody contract set on the second blockchain both belong to the cross-chain transaction protocol (for example, configured in the cross-chain transaction protocol). The asset custody contract set on the first blockchain and the asset custody contract set on the second blockchain may be the same or may be different (for example, compiling formats are different).

Further, the second node device may determine, in the asset processor set on the second blockchain, the asset processor matching the target asset type as the second asset processor. Similarly, the asset processor set on the second blockchain includes one or more asset processors. The asset processor set on the second blockchain may include an asset processor B3 and an asset processor B4. A cross-chain asset contract is deployed on each asset processor in the asset processor set, and the asset processor may perform asset processing based on the cross-chain asset contract. One asset processor in the asset processor set on the second blockchain is configured to process a digital asset of one asset type, thereby facilitating management of digital assets of different asset types. Similarly, the asset processor set on the first blockchain and the asset processor set on the second blockchain both belong to the cross-chain transaction protocol (for example, configured in the cross-chain transaction protocol). The asset processor set on the first blockchain and the asset processor set on the second blockchain may be the same or may be different (for example, compiling formats are different).

Specifically, the second node device may invoke the second asset processor to release the digital asset of the target asset type and the target asset amount from the second asset custody contract to the second account. The second asset custody contract includes a public account. The second node device may invoke the second asset processor to transfer the digital asset of the target asset type and the target asset amount from the public account of the second asset custody contract to the second account. As can be seen, the digital asset is locked in the asset custody contract on the second blockchain. In this way, a cross-chain service provided by the on-chain service execution contract and an asset custody service provided by the asset custody contract can be independent of each other, and the on-chain service execution contract cannot arbitrarily operate a pledged asset of the target cross-chain service in a cross-chain process, thereby further improving asset security. The existence of the asset custody contract makes a cross-chain service provider and an asset custody provider independent of each other, and in an on-chain service, a pledged asset of the target cross-chain service in a cross-chain process cannot be arbitrarily operated, thereby further improving asset security.

Specifically, when the cross-chain transaction data is service data specified by the target cross-chain service, the second node device may process the service data. If the service data is a to-be-processed transaction, the second node device may process the to-be-processed transaction. If the service data is status information of an asset, the second node device may perform service processing according to the status information of the asset.

The embodiments of the present disclosure provide a cross-chain transaction protocol. The cross-chain transaction protocol includes an on-chain part and an off-chain part. The on-chain part includes the on-chain service verification contract (used to verify whether a cross-chain service is legal), the on-chain service execution contract (used to execute a cross-chain service), and an access condition (that is, a risk management rule) for a node device corresponding to a blockchain to join a cross-chain transaction. The off-chain part includes the off-chain data verification contract used by a cross-chain relay device to verify whether cross-chain transaction data that needs to be forwarded is valid. Cross-chain service processing can be automatically implemented by using these contracts in the cross-chain transaction protocol, thereby improving cross-chain service processing efficiency and security. During actual application, when receiving the cross-chain transaction request sent by the service terminal, the first node device invokes the on-chain service verification contract in the cross-chain transaction protocol, to verify whether the target cross-chain service in the cross-chain transaction request is legal. The first node device invokes, if the target cross-chain service is legal, the on-chain service execution contract in the cross-chain transaction protocol to execute the target cross-chain service, to obtain the cross-chain transaction data. As can be seen, whether the target cross-chain service is legal is verified based on the on-chain service verification contract, and the target cross-chain service is executed only when the target cross-chain service is legal, thereby effectively improving cross-chain service processing security.

Further, the first node device may send the cross-chain transaction data to the N cross-chain relay devices associated with the cross-chain transaction protocol. The cross-chain relay device i of the N cross-chain relay devices is configured to transmit the cross-chain transaction data to the second node device in response to determining that the cross-chain transaction data is valid based on the off-chain data verification contract in the cross-chain transaction protocol. In this way, the N cross-chain relay devices verify whether the cross-chain transaction data is valid, and forward valid cross-chain transaction data. This can implement decentralization and avoid cheating risk of centralization when a third-party cross-chain relay device forwards the cross-chain transaction data (for example, the third-party cross-chain relay device still forwards the cross-chain transaction data to the second blockchain when the cross-chain transaction data is invalid). In addition, the cross-chain relay device verifies whether the cross-chain transaction data is valid, to avoid that a large amount of ledger structure data in the first blockchain is sent to the second blockchain (to verify, on the second blockchain, whether the cross-chain transaction data is valid based on the large amount of ledger structure data), and consequently cross-chain service processing costs are relatively high and cross-chain service processing efficiency is relatively low. Therefore, cross-chain service processing costs can be reduced and cross-chain service processing efficiency can be improved. The second node device processes the received cross-chain transaction data only in response to determining that the cross-chain transaction data is valid, thereby improving cross-chain transaction security. In addition, a cross-chain service provided by the on-chain service execution contract and an asset custody service provided by the asset custody contract can be independent of each other, and the on-chain service execution contract cannot arbitrarily operate a pledged asset of the target cross-chain service in a cross-chain process, thereby further improving asset security. The existence of the asset custody contract makes a cross-chain service provider and an asset custody provider independent of each other, and in an on-chain service, a pledged asset of the target cross-chain service in a cross-chain process cannot be arbitrarily operated, thereby further improving asset security.

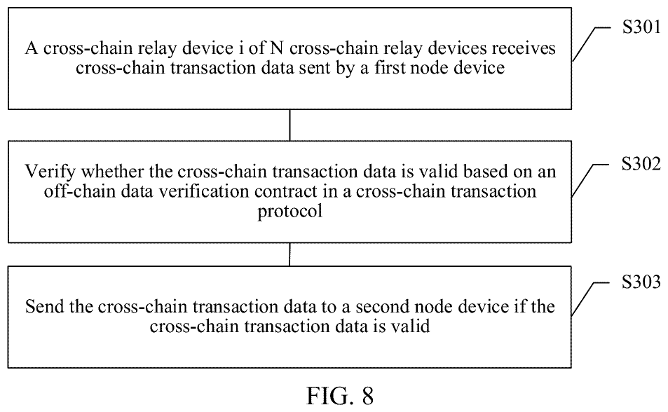

Further, FIG. 8 is a schematic flowchart of a data processing method based on a blockchain according to an embodiment of the present disclosure. As shown in FIG. 8, the method may be performed by a cross-chain relay device i. The cross-chain relay device i may be any cross-chain relay device of N cross-chain relay devices. The cross-chain relay device i may be a server, or may be a terminal device. A specific form of the cross-chain relay device i is not limited herein. The method may include, but is not limited to, at least the following operations:

S301: A cross-chain relay device i of N cross-chain relay devices receives cross-chain transaction data sent by a first node device.

Specifically, the cross-chain relay device i of the N cross-chain relay devices may receive the cross-chain transaction data sent by the first node device. The cross-chain transaction data is generated by the first node device by executing a target cross-chain service when determining that the target cross-chain service is legal based on an on-chain service verification contract in a cross-chain transaction protocol, and is forwarded by the first node device to the N cross-chain relay devices. The target cross-chain service is associated with a first blockchain maintained by the first node device and a second blockchain maintained by a second node device, both the first node device and the second node device satisfy the cross-chain transaction protocol, N is an integer greater than 1, and i is an integer less than or equal to N. Each cross-chain relay device has an independent relay identity (that is, an address and a private key), and the cross-chain relay device independently endorses the detected cross-chain transaction data (that is, forwards the cross-chain transaction data in response to determining that the cross-chain transaction data is valid). A specific process of obtaining the cross-chain transaction data can be found in content of operation S101 to operation S104 in FIG. 6. Details are not described herein again in this embodiment of the present disclosure.

S302: Verify whether the cross-chain transaction data is valid based on an off-chain data verification contract in the cross-chain transaction protocol.

Specifically, the cross-chain relay device i may verify whether the cross-chain transaction data is valid based on the off-chain data verification contract in the cross-chain transaction protocol, that is, verify whether the cross-chain transaction data is real. The off-chain data verification contract may be an off-chain data verification rule that is specified in the cross-chain transaction protocol and that is used by cross-chain relay devices to verify whether the cross-chain transaction data is valid, and is used to verify whether the cross-chain transaction data is valid, that is, verify whether the cross-chain transaction data is real. For example, the cross-chain transaction data includes an asset locking event, and the cross-chain relay device i may verify whether the asset locking event is executed on the first blockchain. The cross-chain relay device i can independently verify whether the cross-chain transaction data is valid. In this way, the N cross-chain relay devices independently verify whether the cross-chain transaction data is valid. This can implement decentralization and avoid cheating risk of centralization when a third-party cross-chain relay device forwards the cross-chain transaction data (for example, the third-party cross-chain relay device still forwards the cross-chain transaction data to the second node device when the cross-chain transaction data is invalid, and as a result, the second node device executes the risky cross-chain transaction data). In addition, the cross-chain relay device i verifies whether the cross-chain transaction data is valid, to improve cross-chain transaction efficiency and avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low.

In some embodiments, the cross-chain transaction data includes an asset locking event used to indicate that a digital asset of a target asset type and a target asset amount in the first account on the first blockchain has been locked. One embodiment of verifying, by the cross-chain relay device i, whether the cross-chain transaction data is valid according to the off-chain data verification contract in the cross-chain transaction protocol may include: obtaining an event identifier of the asset locking event, and detecting to find a target block including the event identifier from the first blockchain; and determining that the cross-chain transaction data is valid if the target block including the event identifier is detected on the first blockchain.

The cross-chain relay device i may obtain the event identifier of the asset locking event, and detect to find the target block including the event identifier from the first blockchain. If the target block including the event identifier is detected on the first blockchain, it indicates that the first node device maintaining the first blockchain has locked the digital asset of the target asset type and the target asset amount in the first account on the first blockchain, and it is determined that the cross-chain transaction data is valid. If the target block including the event identifier is not detected on the first blockchain, it indicates that the first node device maintaining the first blockchain has not locked the digital asset of the target asset type and the target asset amount in the first account on the first blockchain, and it is determined that the cross-chain transaction data is invalid. As can be seen, the cross-chain relay device i verifies whether the cross-chain transaction data is valid, to improve cross-chain transaction efficiency and avoid that a large amount of ledger structure data in the first blockchain is sent to the second blockchain (to verify, on the second blockchain, whether the cross-chain transaction data is valid based on the large amount of ledger structure data), and consequently cross-chain transaction costs are relatively high and cross-chain transaction efficiency is relatively low.

S303: Send the cross-chain transaction data to the second node device in response to the cross-chain transaction data being valid.

Specifically, the second node device processes the received cross-chain transaction data in response to determining that the cross-chain transaction data is valid. Specific content of processing the cross-chain transaction data by the second node device can be found in content of operation S201 to operation S203 in FIG. 7. Details are not described herein again in this embodiment of the present disclosure.

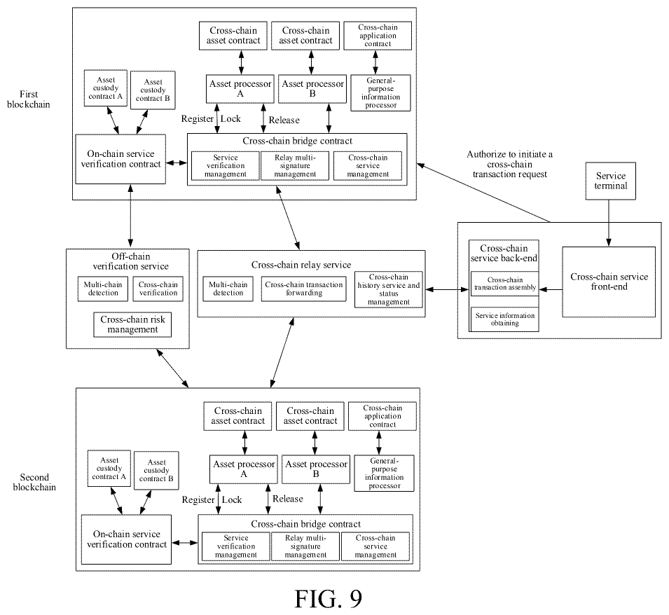

FIG. 9 is a schematic diagram of a cross-chain transaction according to an embodiment of the present disclosure. As shown in FIG. 9, a service object may send, through a cross-chain service front-end in a service terminal, a cross-chain transaction request for a first blockchain and a second blockchain. The cross-chain transaction request includes a target cross-chain service, including asset locking authorization and a cross-chain asset transfer request (that is, an asset release request) on the first blockchain. The service object may initiate a cross-chain asset transfer request in an object account of the cross-chain service front-end. The cross-chain asset transfer request may be used to instruct to transfer a digital asset of the object account from the first blockchain to the second blockchain. The cross-chain service front-end may be an application client, and is responsible for interacting with a cross-chain object (for example, the service object). For example, the cross-chain service front-end may be in a form of a webpage, an application (APP), a mini program, or the like. The cross-chain service back-end may perform transaction assembly on the cross-chain transaction request, and send the cross-chain transaction request to the first blockchain. The first node device maintaining the first blockchain may obtain the cross-chain transaction request. In addition, the cross-chain service back-end may obtain an execution status or other information of the target cross-chain transaction, and return the execution status or other information of the target cross-chain transaction to the cross-chain service front-end, and the cross-chain service front-end may display the execution status or other information of the target cross-chain transaction. The cross-chain service back-end may be a background server, and is mainly configured to provide data and blockchain transaction function support for the cross-chain service front-end.

A cross-chain bridge contract, an on-chain service verification contract, an asset custody contract, a cross-chain asset contract, a cross-chain application contract, and the like are deployed on the first blockchain. The cross-chain bridge contract is an on-chain service execution contract on the first blockchain. The cross-chain bridge contract includes a service verification management function, a relay multi-signature management function, and a cross-chain service management function. The service verification management function may be connected to the on-chain service verification contract on the first blockchain, and is configured to manage invocation of the on-chain service verification contract in a process of submitting and executing a cross-chain service, to ensure controllability of the target cross-chain service. That is, when the target cross-chain service is illegal, the target cross-chain service may not be executed, and when the target cross-chain service is an asset transfer service, an asset specified by the target cross-chain service may be frozen. The target cross-chain service is executed only when the target cross-chain service is legal, to ensure security of the cross-chain transaction. The relay multi-signature management function refers to adding, deleting, modifying, and checking identities of N cross-chain relay devices in a cross-chain relay service of a cross-chain bridge contract, and setting a relay quantity threshold. If M of the N cross-chain relay devices endorse the cross-chain transaction data (that is, forward the cross-chain transaction data), it may be determined that the cross-chain transaction data is valid in the on-chain service execution contract of the second node device, and the cross-chain transaction data is executed (that is, it is considered that the cross-chain transaction data succeeds verification and continues to be executed). The cross-chain service management function may refer to a related process of executing a target cross-chain service. The on-chain service verification contract may manage an asset custody contract, for example, deployment of the asset custody contract, binding an asset custody contract to an asset type or a cross-chain transaction type, or assignment of permission to an operator of the asset custody contract.

Specifically, the first node device maintaining the first blockchain may receive the target cross-chain service in the cross-chain transaction request by using a cross-chain bridge contract, and may invoke the on-chain service verification contract by using the cross-chain bridge contract, to verify whether the target cross-chain service is legal. For example, the target cross-chain service is transferring a digital asset of a target asset type and a target asset amount from a first account on the first blockchain to a second account on the second blockchain. When determining that the target cross-chain service is legal, the cross-chain bridge contract may obtain an asset custody contract matching the target asset type in the asset custody contract set on the first blockchain as the first asset custody contract. The first node device may determine, in the asset processor set on the first blockchain, the asset processor matching the target asset type as the first asset processor by using the cross-chain bridge contract. The asset processor may lock a digital asset of a corresponding asset type to a corresponding asset custody contract or release a digital asset in a corresponding asset custody contract by using a cross-chain asset contract. The first asset processor is invoked by using an address of the first asset custody contract as a parameter. The first asset processor locks the digital asset of the target asset type and the target asset amount in the first account to the first asset custody contract. In this way, a cross-chain service provided by the on-chain service execution contract and an asset custody service provided by the asset custody contract can be independent of each other, and the on-chain service execution contract cannot arbitrarily operate a pledged asset of the target cross-chain service in a cross-chain process, thereby further improving asset security. The existence of the asset custody contract makes a cross-chain service provider and an asset custody provider independent of each other, and in an on-chain service, a pledged asset of the target cross-chain service in a cross-chain process cannot be arbitrarily operated, thereby further improving asset security.

The on-chain service verification contract may determine a service verification type of the target cross-chain service. In response to the service verification type being an on-chain service verification type, the on-chain service verification contract verifies whether the target cross-chain service is legal. In response to the service verification type being an off-chain service verification type, the on-chain service verification contract sends the target cross-chain service to an off-chain verification service, and an off-chain service verification device in the off-chain verification service instructs a service verification object to verify whether the target cross-chain service is legal. The off-chain verification service may include a multi-chain verification function, a cross-chain verification function, and a cross-chain risk management function. The multi-chain verification function refers to detecting an on-chain service verification contract on each blockchain, and obtaining a verification task that requires legality verification. The cross-chain verification function refers to verifying whether an obtained verification service is valid. The cross-chain risk management function is responsible for managing a risky cross-chain service. The off-chain verification service has permission for freezing and transferring digital assets in all asset custody contracts on the chain. When a risky transaction is found, a corresponding risk management operation (for example, locking or transferring) may be performed on a locked asset in the asset custody contract on the chain.

The first node device may generate an asset locking event that indicates that the digital asset of the target asset type and the target asset amount in the first account has been locked to the first asset custody contract, and chain the asset locking event to the first blockchain. In addition, the first node device may generate the asset release request, where the asset release request is used to instruct the second node device to release the digital asset of the target asset type and the target asset amount to the second account. The asset locking event and the asset release request are determined as the cross-chain transaction data of the target cross-chain service, and the cross-chain transaction data is sent to the N cross-chain relay devices in a cross-chain relay service. As shown in FIG. 9, the cross-chain relay service includes a multi-chain detection function, a cross-chain transaction forwarding function, and a cross-chain history service and status management function. The multi-chain detection function means that the N cross-chain relay devices may detect a cross-chain transaction performed by a node device joining the cross-chain transaction protocol. The cross-chain transaction forwarding function means that the cross-chain relay device may verify whether the cross-chain transaction data is valid, and in response to determining that the cross-chain transaction data is valid, forward the cross-chain transaction data to the second node device maintaining the second blockchain. The cross-chain history service and status management function means managing related information and status information of a cross-chain history service. Certainly, when the target cross-chain service is not an asset transaction service, service data specified by the target cross-chain service may be obtained by a general-purpose information processor as the cross-chain transaction data based on a cross-chain application contract, and the cross-chain transaction data is sent to the N cross-chain relay devices.

As shown in FIG. 9, a cross-chain bridge contract, an on-chain service verification contract, an asset custody contract, a cross-chain asset contract, a cross-chain application contract, and the like are also deployed on the second blockchain, and functions thereof are the same as those of the contracts on the first blockchain. The second node device may obtain the relay quantity threshold configured in the on-chain service execution contract on the second blockchain, count a device quantity of cross-chain relay devices sending the cross-chain transaction data, and compare the relay quantity threshold with the device quantity. In response to the device quantity being greater than or equal to the relay quantity threshold, it indicates that most cross-chain relay devices determine that the cross-chain transaction data is valid, and the second node device determines that the asset locking event is valid, and generates the data verification result used to indicate that the cross-chain transaction data succeeds verification. In this way, the second node device determines that the cross-chain transaction data is valid only when determining that the device quantity is greater than or equal to the relay quantity threshold. This can implement decentralization and avoid cheating risk of centralization when a third-party cross-chain relay device forwards the cross-chain transaction data (for example, the third-party cross-chain relay device still forwards the cross-chain transaction data to the second node device when the cross-chain transaction data is invalid, and as a result, the second node device executes the risky cross-chain transaction data).

The embodiments of the present disclosure provide a cross-chain transaction protocol. The cross-chain transaction protocol includes an on-chain part and an off-chain part. The on-chain part includes the on-chain service verification contract (used to verify whether a cross-chain service is legal), the on-chain service execution contract (used to execute a cross-chain service), and an access condition (that is, a risk management rule) for a node device corresponding to a blockchain to join a cross-chain transaction. The off-chain part includes the off-chain data verification contract used by a cross-chain relay device to verify whether cross-chain transaction data that needs to be forwarded is valid. Cross-chain service processing can be automatically implemented by using these contracts in the cross-chain transaction protocol, thereby improving cross-chain service processing efficiency and security. During actual application, when receiving the cross-chain transaction request sent by the service terminal, the first node device invokes the on-chain service verification contract in the cross-chain transaction protocol, to verify whether the target cross-chain service in the cross-chain transaction request is legal. The first node device invokes, if the target cross-chain service is legal, the on-chain service execution contract in the cross-chain transaction protocol to execute the target cross-chain service, to obtain the cross-chain transaction data. As can be seen, whether the target cross-chain service is legal is verified based on the on-chain service verification contract, and the target cross-chain service is executed only when the target cross-chain service is legal, thereby effectively improving cross-chain service processing security.

Further, the first node device may send the cross-chain transaction data to the N cross-chain relay devices associated with the cross-chain transaction protocol. The cross-chain relay device i of the N cross-chain relay devices is configured to transmit the cross-chain transaction data to the second node device in response to determining that the cross-chain transaction data is valid based on the off-chain data verification contract in the cross-chain transaction protocol. In this way, the N cross-chain relay devices verify whether the cross-chain transaction data is valid, and forward valid cross-chain transaction data. This can implement decentralization and avoid cheating risk of centralization when a third-party cross-chain relay device forwards the cross-chain transaction data (for example, the third-party cross-chain relay device still forwards the cross-chain transaction data to the second blockchain when the cross-chain transaction data is invalid). In addition, the cross-chain relay device verifies whether the cross-chain transaction data is valid, to avoid that a large amount of ledger structure data in the first blockchain is sent to the second blockchain (to verify, on the second blockchain, whether the cross-chain transaction data is valid based on the large amount of ledger structure data), and consequently cross-chain service processing costs are relatively high and cross-chain service processing efficiency is relatively low. Therefore, cross-chain service processing costs can be reduced and cross-chain service processing efficiency can be improved. The second node device processes the received cross-chain transaction data only in response to determining that the cross-chain transaction data is valid, thereby improving cross-chain transaction security.

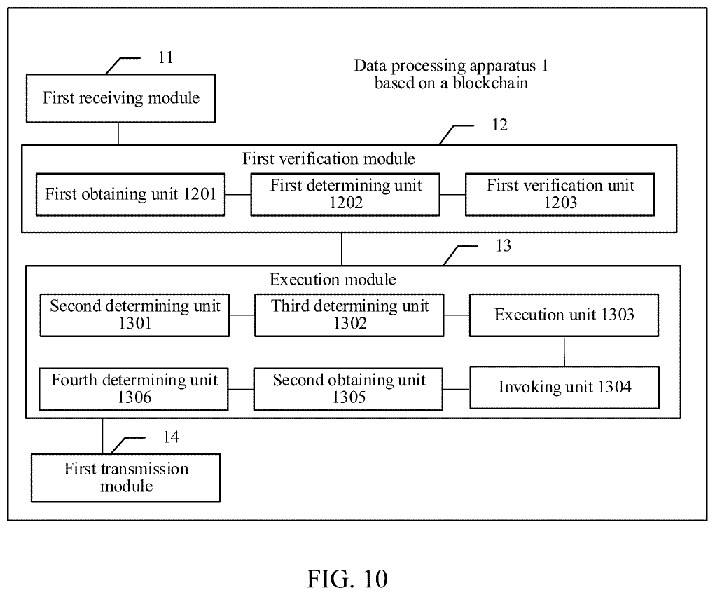

Further, FIG. 10 is a schematic structural diagram of a data processing apparatus based on a blockchain according to an embodiment of the present disclosure. The data processing apparatus 1 based on a blockchain may be a computer program (including program code) running in a computer device. For example, the data processing apparatus 1 based on a blockchain is application software. The data processing apparatus 1 based on a blockchain may be configured to perform the corresponding operations in the method provided in the embodiments of the present disclosure. As shown in FIG. 10, the data processing apparatus 1 based on a blockchain may be a first node device maintaining a first blockchain. The data processing apparatus 1 based on a blockchain may include: a first receiving module 11, a first verification module 12, an execution module 13, and a first transmission module 14.

The first receiving module 11 is configured to receive a cross-chain transaction request sent by a service terminal, the cross-chain transaction request including service description information of a target cross-chain service associated with a first blockchain and a second blockchain, and both a first node device and a second node device that maintains the second blockchain satisfying a cross-chain transaction protocol.

The first verification module 12 is configured to invoke an on-chain service verification contract in the cross-chain transaction protocol, to verify whether the target cross-chain service is legal according to the service description information, to obtain a service verification result.

The execution module 13 is configured to invoke, in response to the service verification result indicating that the target cross-chain service is legal, an on-chain service execution contract in the cross-chain transaction protocol to execute the target cross-chain service, to obtain cross-chain transaction data.

The first transmission module 14 is configured to transmit the cross-chain transaction data to N cross-chain relay devices associated with the cross-chain transaction protocol, a cross-chain relay device i of the N cross-chain relay devices being configured to transmit the cross-chain transaction data to the second node device in response to determining that the cross-chain transaction data is valid based on an off-chain data verification contract in the cross-chain transaction protocol, the second node device being configured to process the received cross-chain transaction data in response to determining that the cross-chain transaction data is valid, N being a positive integer greater than 1, and i being a positive integer less than or equal to N.

The first verification module 12 includes:
a first obtaining unit 1201, configured to invoke the on-chain service verification contract in the cross-chain transaction protocol, to obtain, from the service description information, first service attribute information indicating a service type of the target cross-chain service and second service attribute information indicating a service risk of the target cross-chain service;
a first determining unit 1202, configured to determine a service verification type of the target cross-chain service according to the first service attribute information; and
a first verification unit 1203, configured to verify whether the target cross-chain service is legal according to the service verification type and the second service attribute information, to obtain the service verification result.

The first verification unit 1203 is specifically configured to:
invoke the on-chain service verification contract in response to the service verification type being an on-chain service verification type, to obtain a terminal risk level of the service terminal according to the second service attribute information, and obtain a data risk level of service data specified by the target cross-chain service; and
generate, in response to the terminal risk level being less than a first level threshold and the data risk level is less than a second level threshold, the service verification result for indicating that the target cross-chain service is legal.

Further, the first verification unit 1203 is specifically configured to:
invoke the on-chain service verification contract in response to the service verification type being an off-chain service verification type, to send the second service attribute information to an off-chain service verification device; where the off-chain service verification device is configured to instruct a service verification object to perform a verification operation on the target cross-chain service based on the second service attribute information;
receive an operation result of the verification operation that is returned by the off-chain service verification device; and
generate the service verification result of the target cross-chain service according to the operation result.

The target cross-chain service is used to instruct to transfer a digital asset of a target asset type.

The execution module 13 includes:
a second determining unit 1301, configured to invoke the on-chain service execution contract in the cross-chain transaction protocol in response to the service verification result indicating that the target cross-chain service is legal, to determine, in an asset custody contract set on the first blockchain, an asset custody contract matching the target asset type as a first asset custody contract;
a third determining unit 1302, configured to determine, in an asset processor set on the first blockchain, an asset processor matching the target asset type as a first asset processor; and
an execution unit 1303, configured to execute the target cross-chain service according to the first asset custody contract and the first asset processor, to obtain the cross-chain transaction data.

The digital asset of the target asset type belongs to a first account on the first blockchain, and an amount of the digital asset is a target asset amount.

The execution unit 1303 is specifically configured to:
invoke the first asset processor to lock the digital asset of the target asset type and the target asset amount in the first account to the first asset custody contract;
generate an asset locking event that indicates that the digital asset of the target asset type and the target asset amount in the first account has been locked to the first asset custody contract;
generate a chaining request for the asset locking event, and send the chaining request to a consensus node of the first blockchain; where the consensus node of the first blockchain is configured to perform consensus on the asset locking event, to obtain a consensus result; and
receive the consensus result returned by the consensus node of the first blockchain, and generate the cross-chain transaction data of the target cross-chain service according to the consensus result.

The target cross-chain service is further used to instruct to transfer the digital asset of the target asset type and the target asset amount to a second account on the second blockchain.

The generating the cross-chain transaction data of the target cross-chain service according to the consensus result includes:
chaining the asset locking event to the first blockchain in response to the consensus result indicating that the consensus on the asset locking event succeeds;
generating an asset release request, where the asset release request is used to instruct the second node device to release the digital asset of the target asset type and the target asset amount from a second asset custody contract to the second account, where the second asset custody contract is an asset custody contract that is associated with the target asset type and that is on the second blockchain; and
determining the asset locking event and the asset release request as the cross-chain transaction data of the target cross-chain service.

The execution module 13 includes:
an invoking unit 1304, configured to invoke a general-purpose message processor on the first blockchain based on the on-chain service execution contract in the cross-chain transaction protocol in response to the service verification result indicating that the target cross-chain service is legal and the target cross-chain service is of a non-asset-transaction type;
a second obtaining unit 1305, configured to obtain, from the first blockchain by using the general-purpose message processor, the service data specified by the target cross-chain service; and
a fourth determining unit 1306, configured to determine the service data specified by the target cross-chain service as the cross-chain transaction data of the target cross-chain service.

According to an embodiment of the present disclosure, the modules in the data processing apparatus 1 based on a blockchain shown in FIG. 10 may be separately or all combined into one or a plurality of units, or one (or some) of the units may be further split into at least two small subunits by function, which can implement the same operations without affecting the implementation of the technical effects of the embodiments of the present disclosure. The foregoing modules are divided based on logical functions. In an actual application, a function of one module may also be implemented by at least two units, or functions of at least two modules are implemented by one unit. In other embodiments of the present disclosure, the data processing apparatus 1 based on a blockchain may also include another unit. In an actual application, these functions may be implemented with assistance of other units, and may be implemented with assistance of at least two units. The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units.

According to an embodiment of the present disclosure, a computer program (including program code) that can perform the operations involved in the corresponding methods shown in FIG. 6 may be run on a general-purpose computer device such as a computer including processing components such as a central processing unit (CPU) and storage components such as a random access memory (RAM) and a read-only memory (ROM), to construct the data processing apparatus 1 based on a blockchain shown in FIG. 10 and implement the data processing method based on a blockchain in the embodiments of the present disclosure. The computer program may be recorded in, for example, a computer-readable recording medium, and may be loaded into the foregoing computer device by using the computer-readable recording medium, and run in the computer device. For description of beneficial effects of the data processing apparatus 1 based on a blockchain shown in FIG. 10, refer to description of beneficial effects of the corresponding method in FIG. 6. Details are not described herein again in this embodiment of the present disclosure.

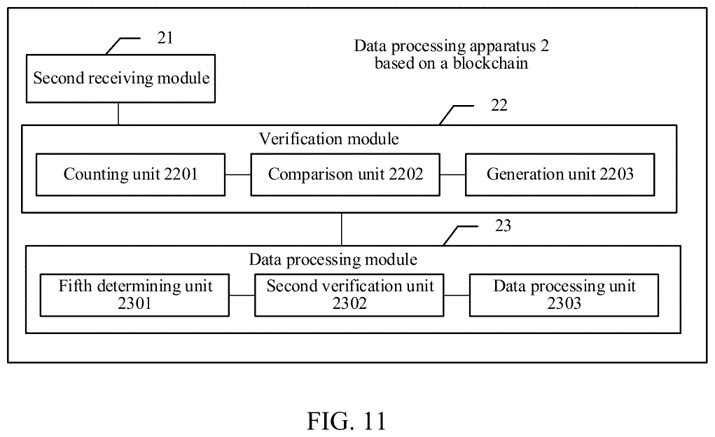

Further, FIG. 11 is a schematic structural diagram of a data processing apparatus based on a blockchain according to an embodiment of the present disclosure. The data processing apparatus 2 based on a blockchain may be a computer program (including program code) running in a computer device. For example, the data processing apparatus 2 based on a blockchain is application software. The data processing apparatus 2 based on a blockchain may be configured to perform the corresponding operations in the method provided in the embodiments of the present disclosure. As shown in FIG. 11, the data processing apparatus 2 based on a blockchain may be a second node device maintaining a second blockchain. The data processing apparatus 2 based on a blockchain may include: a second receiving module 21, a verification module 22, and a data processing module 23.

The second receiving module 21 is configured to receive cross-chain transaction data sent by a cross-chain relay device i of N cross-chain relay devices, the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the cross-chain relay device i being configured to transmit the cross-chain transaction data to the second node device in response to determining that the cross-chain transaction data is valid based on an off-chain data verification contract in the cross-chain transaction protocol, the target cross-chain service being associated with a first blockchain maintained by the first node device and the second blockchain, both the first node device and the second node device satisfying the cross-chain transaction protocol, N being an integer greater than 1, and i being an integer less than or equal to N.

The verification module 22 is configured to verify whether the received cross-chain transaction data is valid based on an on-chain service execution contract in the cross-chain transaction protocol, to obtain a data verification result.

The data processing module 23 is configured to process the cross-chain transaction data when the data verification result indicates that the cross-chain transaction data is valid.

The cross-chain transaction data includes an asset locking event used to indicate that a digital asset of a target asset type and a target asset amount in a first account of a first blockchain has been locked.

The verification module 22 includes:
a counting unit 2201, configured to obtain a relay quantity threshold configured in the on-chain service execution contract in the cross-chain transaction protocol, and count a device quantity of cross-chain relay devices that send the cross-chain transaction data;
a comparison unit 2202, configured to compare the relay quantity threshold with the device quantity; and
a generation unit 2203, configured to determine that the asset locking event is valid in response to the device quantity being greater than or equal to the relay quantity threshold, and generate the data verification result for indicating that the cross-chain transaction data is valid.

The data processing module 23 includes:
a fifth determining unit 2301, configured to invoke the on-chain service verification contract in the cross-chain transaction protocol when the data verification result indicates that the cross-chain transaction data is valid, to determine a data verification type of the cross-chain transaction data;
a second verification unit 2302, configured to verify whether the cross-chain transaction data is risky according to the data verification type, to obtain a risk verification result; and
a data processing unit 2303, configured to process the cross-chain transaction data when the risk verification result indicates that the cross-chain transaction data is not risky data.

The cross-chain transaction data includes an asset release request, and the asset release request is used to instruct the second node device to release the digital asset of the target asset type and the target asset amount to a second account of the second blockchain.

The data processing unit 2303 is specifically configured to:
determine, in an asset custody contract set on the second blockchain, an asset custody contract matching the target asset type as a second asset custody contract when the risk verification result indicates that the cross-chain transaction data is not risky data;
determine, in an asset processor set on the second blockchain, an asset processor matching the target asset type as a second asset processor; and
invoke the second asset processor to release the digital asset of the target asset type and the target asset amount from the second asset custody contract to the second account.

According to an embodiment of the present disclosure, the modules in the data processing apparatus 2 based on a blockchain shown in FIG. 11 may be separately or all combined into one or a plurality of units, or one (or some) of the units may be further split into at least two small subunits by function, which can implement the same operations without affecting the implementation of the technical effects of the embodiments of the present disclosure. The foregoing modules are divided based on logical functions. In an actual application, a function of one module may also be implemented by at least two units, or functions of at least two modules are implemented by one unit. In other embodiments of the present disclosure, the data processing apparatus 2 based on a blockchain may also include another unit. In an actual application, these functions may be implemented with assistance of other units, and may be implemented with assistance of at least two units.

According to an embodiment of the present disclosure, a computer program (including program code) that can perform the operations involved in the corresponding methods shown in FIG. 7 may be run on a general-purpose computer device such as a computer including processing components such as a central processing unit (CPU) and storage components such as a random access memory (RAM) and a read-only memory (ROM), to construct the data processing apparatus 2 based on a blockchain shown in FIG. 11 and implement the data processing method based on a blockchain in the embodiments of the present disclosure. The computer program may be recorded in, for example, a computer-readable recording medium, and may be loaded into the foregoing computer device by using the computer-readable recording medium, and run in the computer device. For description of beneficial effects of the data processing apparatus 2 based on a blockchain shown in FIG. 11, refer to description of beneficial effects of the corresponding method in FIG. 7. Details are not described herein again in this embodiment of the present disclosure.

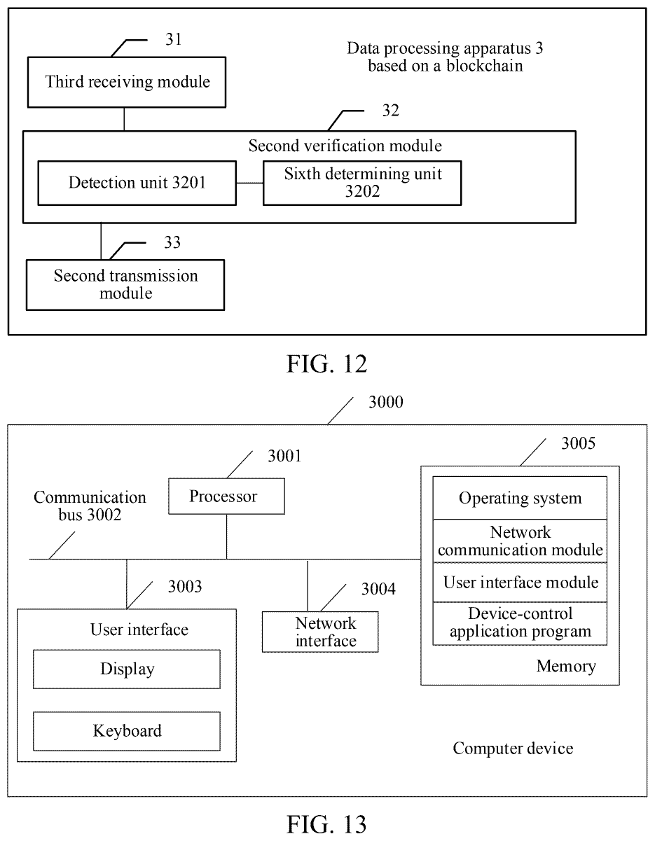

Further, FIG. 12 is a schematic structural diagram of a data processing apparatus based on a blockchain according to an embodiment of the present disclosure. The data processing apparatus 3 based on a blockchain may be a computer program (including program code) running in a computer device. For example, the data processing apparatus 3 based on a blockchain is application software. The data processing apparatus 3 based on a blockchain may be configured to perform the corresponding operations in the method provided in the embodiments of the present disclosure. As shown in FIG. 12, the data processing apparatus 3 based on a blockchain may be a cross-chain relay device. The data processing apparatus 3 based on a blockchain may include: a third receiving module 31, a second verification module 32, and a second transmission module 33.

The third receiving module 31 is configured to receive cross-chain transaction data sent by a first node device; the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the target cross-chain service being associated with a first blockchain maintained by the first node device and a second blockchain maintained by a second node device, both the first node device and the second node device satisfying the cross-chain transaction protocol, N being an integer greater than 1, and i being an integer less than or equal to N.

The second verification module 32 is configured to verify whether the cross-chain transaction data is valid based on an off-chain data verification contract in the cross-chain transaction protocol.

The second transmission module 33 is configured to transmit the cross-chain transaction data to the second node device in response to the cross-chain transaction data being valid, the second node device being configured to process the received cross-chain transaction data in response to determining that the cross-chain transaction data is valid.

The cross-chain transaction data includes an asset locking event used to indicate that a digital asset of a target asset type and a target asset amount in a first account of a first blockchain has been locked.

The second verification module 32 includes:
a detection unit 3201, configured to obtain an event identifier of the asset locking event, and detect to find a target block including the event identifier from the first blockchain; and
a sixth determining unit 3202, configured to determine that the cross-chain transaction data is valid if the target block including the event identifier is detected on the first blockchain.

According to an embodiment of the present disclosure, the modules in the data processing apparatus 3 based on a blockchain shown in FIG. 12 may be separately or all combined into one or a plurality of units, or one (or some) of the units may be further split into at least two small subunits by function, which can implement the same operations without affecting the implementation of the technical effects of the embodiments of the present disclosure. The foregoing modules are divided based on logical functions. In an actual application, a function of one module may also be implemented by at least two units, or functions of at least two modules are implemented by one unit. In other embodiments of the present disclosure, the data processing apparatus 3 based on a blockchain may also include another unit. In an actual application, these functions may be implemented with assistance of other units, and may be implemented with assistance of at least two units.

According to an embodiment of the present disclosure, a computer program (including program code) that can perform the operations involved in the corresponding methods shown in FIG. 8 may be run on a general-purpose computer device such as a computer including processing components such as a central processing unit (CPU) and storage components such as a random access memory (RAM) and a read-only memory (ROM), to construct the data processing apparatus based on a blockchain shown in FIG. 12 and implement the data processing method based on a blockchain in the embodiments of the present disclosure. The computer program may be recorded in, for example, a computer-readable recording medium, and may be loaded into the foregoing computer device by using the computer-readable recording medium, and run in the computer device. For description of beneficial effects of the data processing apparatus 3 based on a blockchain shown in FIG. 12, refer to description of beneficial effects of the corresponding method in FIG. 8. Details are not described herein again in this embodiment of the present disclosure.

Further, FIG. 13 is a schematic diagram of a computer device according to an embodiment of the present disclosure. As shown in FIG. 13, the computer device 3000 may include: at least one processor 3001, for example, a CPU, at least one network interface 3004, a user interface 3003, a memory 3005, and at least one communication bus 3002. The communication bus 3002 is configured to implement connection and communication between these components. The user interface 3003 may include a display, a keyboard. In some embodiments, the network interface 3004 may include a standard wired interface and a standard wireless interface (for example, a WI-FI interface). The memory 3005 may be a high-speed RAM memory, or may be a non-volatile memory, for example, at least one magnetic disk memory. In some embodiments, the memory 3005 may alternatively be at least one storage apparatus that is located far away from the foregoing processor 3001. As shown in FIG. 13, the memory 3005 used as a computer storage medium may include an operating system, a network communication module, a user interface module, and a device-control application program.

In the computer device 3000 shown in FIG. 13, the network interface 3004 is mainly configured for network communication of the second node device with a target relay server and a target oracle server. The user interface 3003 is mainly configured to provide an input interface for a user. The processor 3001 may be configured to invoke the device-control application program stored in the memory 3005.

The computer device 3000 described in this embodiment of the present disclosure can implement the description of the data processing method based on a blockchain in the foregoing embodiment corresponding to FIG. 6, FIG. 7, or FIG. 8, and can also implement the description of the data processing apparatus 1 based on a blockchain in the foregoing embodiment corresponding to FIG. 10, or the description of the data processing apparatus 2 based on a blockchain in the foregoing embodiment corresponding to FIG. 11, or the description of the data processing apparatus 3 based on a blockchain in the foregoing embodiment corresponding to FIG. 12. Details are not described herein again. In addition, the description of beneficial effects of the same method is not described herein again.

Besides, an embodiments of the present disclosure further provides a computer-readable storage medium. The computer-readable storage medium stores a computer program executed by the data processing apparatus 1 based on a blockchain, the data processing apparatus 2 based on a blockchain, or the data processing apparatus 3 based on a blockchain that are mentioned above, and the computer program includes program instructions. When executing the program instructions, the processor can perform the description of the data processing method based on a blockchain in the embodiment corresponding to FIG. 6, FIG. 7, or FIG. 8. Therefore, details are not described herein again. In addition, the description of beneficial effects of the same method is not described herein again. For technical details that are not disclosed in the embodiments of the computer-readable storage medium included in the present disclosure, refer to the description about the method embodiments of the present disclosure. As an example, the program instructions may be deployed on one computing device, or executed on multiple computing devices located at one position, or executed on multiple computing devices distributed at multiple positions and interconnected by using a communication network, and a blockchain system can be formed by multiple computing devices distributed at multiple positions and interconnected by using a communication network.

According to one aspect of the present disclosure, a computer program product or a computer program is provided, including computer instructions, and the computer instructions being stored in a computer-readable storage medium. A processor of a computer device reads the computer instructions from the computer-readable storage medium, and the processor executes the computer instructions, to cause the computer device to execute the description of the data processing method based on a blockchain in the foregoing embodiment corresponding to FIG. 6, FIG. 7, or FIG. 8. Details are not described herein again. In addition, the description of beneficial effects of the same method is not described herein again.

Persons of ordinary skill in the art may understand that all or some of the procedures of the methods in the embodiments may be implemented by using a computer program instructing relevant hardware. The program may be stored in a computer-readable storage medium. When the program runs, the procedures of the methods in the embodiments are performed. The foregoing storage medium may include a magnetic disc, an optical disc, a read-only memory (ROM), a random access memory (RAM), or the like.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method based on a blockchain, comprising:
receiving, by a first node device associated with a first blockchain, a cross-chain transaction request sent by a service terminal, the cross-chain transaction request comprising service description information of a target cross-chain service associated with a first blockchain and a second blockchain, and both the first node device and a second node device that maintains the second blockchain satisfying a cross-chain transaction protocol;
invoking an on-chain service verification contract in the cross-chain transaction protocol, to verify whether the target cross-chain service is legal according to the service description information, to obtain a service verification result;
invoking, in response to the service verification result indicating that the target cross-chain service is legal, an on-chain service execution contract in the cross-chain transaction protocol to execute the target cross-chain service, to obtain cross-chain transaction data; and
transmitting the cross-chain transaction data to N cross-chain relay devices associated with the cross-chain transaction protocol, a cross-chain relay device i of the N cross-chain relay devices being configured to transmit the cross-chain transaction data to the second node device in response to determining that the cross-chain transaction data is valid based on an off-chain data verification contract in the cross-chain transaction protocol, the second node device being configured to process the received cross-chain transaction data in response to determining that the cross-chain transaction data is valid, N being a positive integer greater than 1, and i being a positive integer less than or equal to N.

2. The method according to claim 1, wherein the invoking an on-chain service verification contract in the cross-chain transaction protocol, to verify whether the target cross-chain service is legal according to the service description information, to obtain a service verification result comprises:
invoking the on-chain service verification contract in the cross-chain transaction protocol, to obtain, from the service description information, first service attribute information indicating a service type of the target cross-chain service and second service attribute information indicating a service risk of the target cross-chain service;
determining a service verification type of the target cross-chain service according to the first service attribute information; and
verifying whether the target cross-chain service is legal according to the service verification type and the second service attribute information, to obtain the service verification result.

3. The method according to claim 2, wherein the verifying whether the target cross-chain service is legal according to the service verification type and the second service attribute information, to obtain the service verification result comprises:
invoking the on-chain service verification contract in response to the service verification type being an on-chain service verification type, to obtain a terminal risk level of the service terminal according to the second service attribute information, and obtain a data risk level of service data specified by the target cross-chain service; and
generating, in response to the terminal risk level being less than a first level threshold and the data risk level is less than a second level threshold, the service verification result for indicating that the target cross-chain service is legal.

4. The method according to claim 2, wherein the verifying whether the target cross-chain service is legal according to the service verification type and the second service attribute information, to obtain the service verification result comprises:
invoking the on-chain service verification contract in response to the service verification type being an off-chain service verification type, and sending the second service attribute information to an off-chain service verification device, wherein the off-chain service verification device is configured to instruct a service verification object to perform a verification operation on the target cross-chain service based on the second service attribute information;
receiving an operation result of the verification operation that is returned by the off-chain service verification device; and
generating the service verification result of the target cross-chain service according to the operation result.

5. The method according to claim 1, wherein the target cross-chain service is configured to instruct to transfer a digital asset of a target asset type; and
the invoking, in response to the service verification result indicating that the target cross-chain service is legal, an on-chain service execution contract in the cross-chain transaction protocol to execute the target cross-chain service, to obtain cross-chain transaction data comprises:
invoking the on-chain service execution contract in the cross-chain transaction protocol in response to the service verification result indicating that the target cross-chain service is legal, to determine, in an asset custody contract set on the first blockchain, an asset custody contract matching the target asset type as a first asset custody contract;
determining, in an asset processor set on the first blockchain, an asset processor matching the target asset type as a first asset processor; and
executing the target cross-chain service according to the first asset custody contract and the first asset processor, to obtain the cross-chain transaction data.

6. The method according to claim 5, wherein the digital asset of the target asset type belongs to a first account on the first blockchain, and an amount of the digital asset is a target asset amount; and
the executing the target cross-chain service according to the first asset custody contract and the first asset processor, to obtain the cross-chain transaction data comprises:
invoking the first asset processor to lock the digital asset of the target asset type and the target asset amount in the first account to the first asset custody contract;
generating an asset locking event that indicates that the digital asset of the target asset type and the target asset amount in the first account has been locked to the first asset custody contract;
generating a chaining request for the asset locking event, and sending the chaining request to a consensus node of the first blockchain; wherein the consensus node of the first blockchain is configured to perform consensus on the asset locking event, to obtain a consensus result; and
receiving the consensus result returned by the consensus node of the first blockchain, and generating the cross-chain transaction data of the target cross-chain service according to the consensus result.

7. The method according to claim 6, wherein the target cross-chain service is further used to instruct to transfer the digital asset of the target asset type and the target asset amount to a second account on the second blockchain; and
the generating the cross-chain transaction data of the target cross-chain service according to the consensus result comprises:
chaining the asset locking event to the first blockchain in response to the consensus result indicating that the consensus on the asset locking event succeeds;
generating an asset release request, wherein the asset release request is configured to instruct the second node device to release the digital asset of the target asset type and the target asset amount from a second asset custody contract to the second account, wherein the second asset custody contract is an asset custody contract that is associated with the target asset type and that is on the second blockchain; and
determining the asset locking event and the asset release request as the cross-chain transaction data of the target cross-chain service.

8. The method according to claim 1, wherein the invoking, in response to the service verification result indicating that the target cross-chain service is legal, an on-chain service execution contract in the cross-chain transaction protocol to execute the target cross-chain service, to obtain cross-chain transaction data comprises:
invoking a general-purpose message processor on the first blockchain based on the on-chain service execution contract in the cross-chain transaction protocol in response to the service verification result indicating that the target cross-chain service is legal and the target cross-chain service is of a non-asset-transaction type;
obtaining, from the first blockchain by using the general-purpose message processor, the service data specified by the target cross-chain service; and
determining the service data specified by the target cross-chain service as the cross-chain transaction data of the target cross-chain service.

9. A computer device for the first node device associated with the first blockchain, comprising: a processor and a memory;
the memory being connected to the processor, the memory being configured to store a computer program, and the processor being configured to invoke the computer program and perform the method according to claim 1.

10. A non-transitory computer-readable storage medium, having a computer program stored therein, and the computer program being loaded and executed by a processor, causing the processor to perform the method according to claim 1.

11. A data processing method based on a blockchain, comprising:
receiving, by a second node device associated with a second blockchain, cross-chain transaction data sent by a cross-chain relay device i of N cross-chain relay devices, the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the cross-chain relay device i being configured to transmit the cross-chain transaction data to the second node device in response to determining that the cross-chain transaction data is valid based on an off-chain data verification contract in the cross-chain transaction protocol, the target cross-chain service being associated with a first blockchain maintained by the first node device and the second blockchain, both the first node device and the second node device satisfying the cross-chain transaction protocol, N being an integer greater than 1, and i being an integer less than or equal to N;
verifying whether the received cross-chain transaction data is legal based on an on-chain service execution contract in the cross-chain transaction protocol, to obtain a data verification result; and
processing the cross-chain transaction data when the data verification result indicates that the cross-chain transaction data is valid.

12. The method according to claim 11, wherein the cross-chain transaction data comprises an asset locking event used to indicate that a digital asset of a target asset type and a target asset amount in a first account of a first blockchain has been locked; and
the verifying whether the received cross-chain transaction data is legal based on an on-chain service execution contract in the cross-chain transaction protocol, to obtain a data verification result comprises:
obtaining a relay quantity threshold configured in the on-chain service execution contract in the cross-chain transaction protocol, and counting a device quantity of cross-chain relay devices that send the cross-chain transaction data;
comparing the relay quantity threshold with the device quantity; and
determining that the asset locking event is valid in response to the device quantity being greater than or equal to the relay quantity threshold, and generating the data verification result for indicating that the cross-chain transaction data is valid.

13. The method according to claim 11, wherein the processing the cross-chain transaction data when the data verification result indicates that the cross-chain transaction data is valid comprises:
invoking the on-chain service verification contract in the cross-chain transaction protocol when the data verification result indicates that the cross-chain transaction data is valid, to determine a data verification type of the cross-chain transaction data;
verifying whether the cross-chain transaction data is risky according to the data verification type, to obtain a risk verification result; and
processing the cross-chain transaction data when the risk verification result indicates that the cross-chain transaction data is not risky data.

14. The method according to claim 13, wherein the cross-chain transaction data comprises an asset release request, and the asset release request is configured to instruct the second node device to release the digital asset of the target asset type and the target asset amount to a second account of the second blockchain; and
the processing the cross-chain transaction data when the risk verification result indicates that the cross-chain transaction data is not risky data comprises:
determining, in an asset custody contract set on the second blockchain, an asset custody contract matching the target asset type as a second asset custody contract when the risk verification result indicates that the cross-chain transaction data is not risky data;
determining, in an asset processor set on the second blockchain, an asset processor matching the target asset type as a second asset processor; and
invoking the second asset processor to release the digital asset of the target asset type and the target asset amount from the second asset custody contract to the second account.

15. A computer device for the second node device associated with the second blockchain, comprising: a processor and a memory;
the memory being connected to the processor, the memory being configured to store a computer program, and the processor being configured to invoke the computer program and perform the method according to claim 11.

16. A non-transitory computer-readable storage medium, having a computer program stored therein, and the computer program being loaded and executed by a processor, causing the processor to perform the method according to claim 11.

17. A data processing method based on a blockchain, comprising:
receiving, by a cross-chain relay device i of N cross-chain relay devices, cross-chain transaction data sent by a first node device; the cross-chain transaction data being generated by the first node device by executing a target cross-chain service when determining that the target cross-chain service is legal based on an on-chain service verification contract in a cross-chain transaction protocol, and being forwarded by the first node device to the N cross-chain relay devices, the target cross-chain service being associated with a first blockchain maintained by the first node device and a second blockchain maintained by a second node device, both the first node device and the second node device satisfying the cross-chain transaction protocol, N being an integer greater than 1, and i being an integer less than or equal to N;
verifying whether the cross-chain transaction data is valid based on an off-chain data verification contract in the cross-chain transaction protocol; and
sending the cross-chain transaction data to the second node device in response to the cross-chain transaction data being valid, the second node device being configured to process the received cross-chain transaction data in response to determining that the cross-chain transaction data is valid.

18. The method according to claim 17, wherein the cross-chain transaction data comprises an asset locking event used to indicate that a digital asset of a target asset type and a target asset amount in a first account of a first blockchain has been locked; and
the verifying whether the cross-chain transaction data is valid based on an off-chain data verification contract in the cross-chain transaction protocol comprises:
obtaining an event identifier of the asset locking event, and detecting to find a target block comprising the event identifier from the first blockchain; and
determining that the cross-chain transaction data is valid in response to the target block comprising the event identifier being detected on the first blockchain.

19. A computer device for the cross-chain relay device, comprising: a processor and a memory;
the memory being connected to the processor, the memory being configured to store a computer program, and the processor being configured to invoke the computer program, so that the computer device performs the method according to claim 18.

20. A non-transitory computer-readable storage medium, having a computer program stored therein, and the computer program being loaded and executed by a processor, causing the processor to perform the method according to claim 18.
